(19) United States
(12) Patent Application Publication
(10) Pub. No.: US 2025/0358233 A1
(43) Pub. Date: Nov. 20, 2025

(54) VIRTUAL EXECUTION ENVIRONMENTS AND INTERFACE CIRCUITRY IN TIME-SENSITIVE NETWORKING

(71) Applicants: Piotr Wojciech Uminski, Gdynia (PL); Venkata Ramana Rao Vallabhu, Portland, OR (US); Dave Alberto Cavalcanti, Portland, OR (US); Pauline Mei Lan Chan, Gelugor (MY); Hamza Chahed, Zorneding (DE)

(72) Inventors: Piotr Wojciech Uminski, Gdynia (PL); Venkata Ramana Rao Vallabhu, Portland, OR (US); Dave Alberto Cavalcanti, Portland, OR (US); Pauline Mei Lan Chan, Gelugor (MY); Hamza Chahed, Zorneding (DE)

(21) Appl. No.: 19/286,816

(22) Filed: Jul. 31, 2025

(51) Int. Cl. H04L 47/28; G06F 21/53; H04L 47/2416

(52) U.S. Cl. CPC H04L 47/28; G06F 21/53; H04L 47/2416

(57) ABSTRACT

Systems, apparatus, articles of manufacture, and methods are disclosed for virtual execution environments and interface circuitry in time-sensitive networking. An example compute device includes interface circuitry, machine-readable instructions, and at least one programmable circuit to be programmed by the machine-readable instructions. The example at least one programmable circuit is to be programmed execute a first application for a time-sensitive network (TSN) in a first virtual execution environment (VEE) and execute a second application for the TSN in a second VEE. Additionally, the example at least one programmable circuit is to cause first real-time traffic to be sent from the first application to the interface circuitry based on a first schedule and cause second real-time traffic to be sent from the second application to the interface circuitry based on a second schedule such that transmission of the first real-time traffic does not occur at the same time as transmission of the second real-time traffic.

### BACKGROUND

The Institute of Electrical and Electronics Engineers (IEEE) has developed standards to handle time sensitive processes for information technology (IT) and operational technology (OT) network equipment. For example, emerging IEEE standards for deterministic networking, referred to collectively as time-sensitive networking (TSN), provide extremely precise data transfer across a network.

### BRIEF DESCRIPTION OF THE DRAWINGS

FIG. 1 is a block diagram of an example time-sensitive networking (TSN) capable system constructed according to the International Electrotechnical Commission (IEC)/Institute of Electrical and Electronics Engineers (IEEE) 60802 TSN profile.

FIG. 2 is a block diagram of an example TSN capable system where respective example compute platforms include at least one instance of example configuration manager circuitry.

FIG. 3 is a sequence diagram illustrating example operations of the TSN capable system of FIG. 2.

FIG. 4 is a block diagram of an example TSN capable system including three example industrial automation (IA) controllers managing three example industrial processes.

FIG. 5 is a block diagram of an example implementation of the configuration manager circuitry of FIG. 2.

FIG. 6 is a graphical illustration of an example data path template.

FIG. 7A is a block diagram of a first example data path.

FIG. 7B is a block diagram of a second example data path.

FIG. 8 is a flowchart representative of example machine-readable instructions and/or example operations that may be executed, instantiated, and/or performed by example programmable circuitry to implement the configuration manager circuitry of FIG. 5 at the compute platform level as illustrated in the second compute platform of FIG. 2.

FIG. 9 is a flowchart representative of example machine-readable instructions and/or example operations that may be executed, instantiated, and/or performed by example programmable circuitry to generate respective configurations for data paths between two or more applications and interface circuitry when the configuration manager circuitry of FIG. 5 is implemented at the compute platform level.

FIG. 10 is a flowchart representative of example machine-readable instructions and/or example operations that may be executed, instantiated, and/or performed by example programmable circuitry to implement the configuration manager circuitry of FIG. 5 at the virtual execution environment (VEE) level as illustrated in the third compute platform of FIG. 2.

FIG. 11 is a flowchart representative of example machine-readable instructions and/or example operations that may be executed, instantiated, and/or performed by example programmable circuitry to generate respective configurations for data paths between two or more applications and interface circuitry when the configuration manager circuitry of FIG. 5 is implemented at the VEE level.

FIG. 12 is a block diagram of an example processing platform including programmable circuitry structured to execute, instantiate, and/or perform the example machine-readable instructions and/or perform the example operations of FIGS. 8, 9, 10, and/or 11 to implement the configuration manager circuitry of FIG. 5 and/or the quality of service (QoS) protection circuitry of FIG. 2.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, and/or firmware (e.g., corresponding to the example machine-readable instructions of FIGS. 8, 9, 10, and/or 11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Time-sensitive networking (TSN) enhances network equipment (e.g., Ethernet, wireless fidelity (Wi-Fi), fifth generation (5G), etc. network equipment) with deterministic performance, defined by the Institute of Electrical and Electronics Engineers (IEEE) 802.1 working group. The International Electrotechnical Commission (IEC) and the IEEE define TSN profiles to facilitate the adoption of TSN. In general, TSN profiles build on basic TSN features, such as time synchronization and traffic shaping, to drive adoption in particular industry applications or verticals.

As used herein, a TSN profile refers to one or more features, options, configurations, defaults, protocols, and/or procedures for network equipment in a particular industry application or vertical. For example, the IEC/IEEE 60802 TSN profile defines one or more features, options, configurations, defaults, protocols, and/or procedures for network equipment in industrial automation. Other TSN profiles are available for automotive, professional audio/visual, and aerospace applications, among others. Network equipment can be certified by the Avnu Alliance as compliant with TSN requirements.

In TSN, there are different classes of the traffic, with different priorities and requirements for quality of service (QoS). Real-time traffic usually has cyclic characteristic. For example, real-time traffic includes a pre-defined amount of data that is transmitted in cycles with a pre-defined frequency. The goal of TSN is to transmit high priority, real-time traffic with minimum latency and with minimum jitter. Non-real-time traffic does not have such strict requirements and may be transmitted with lower priority. In a TSN application including a single producer generating two traffic classes, the producer transmits real-time traffic periodically with a fixed period between real-time traffic transmissions during which non-real-time traffic may be transmitted. This scheme can be extended to more traffic classes.

When multiple producers are connected to the same network, real-time traffic from each producer should be coordinated to avoid increased latency and jitter. Coordinating real-time traffic can be done, for example, by defining periods when a producer can transmit real-time traffic, periods when the producer can transmit non-real-time traffic, and periods when the producer suspends transmission to allow for other producers to transmit real-time traffic. In a TSN application including two producers with each producer generating two traffic classes, each producer transmits real-time traffic periodically with the same cycle but with an offset between the producers. As such, real-time traffic from both producers is received by a consumer without delay and with minimum jitter. This scheme can be extended to more traffic classes, more producers, and/or for different cycles used for each producer.

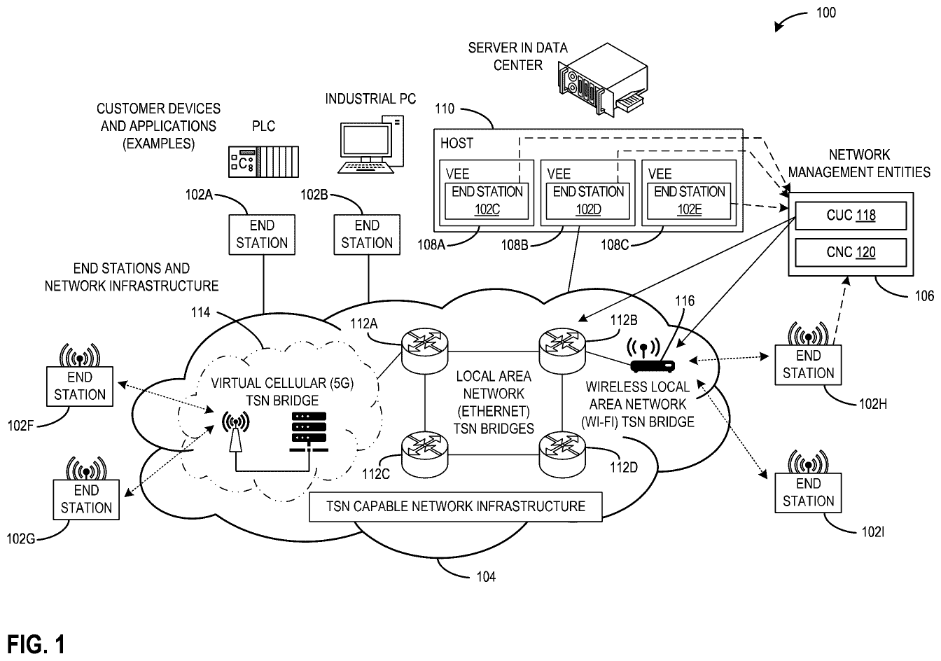

FIG. 1 is a block diagram of an example time-sensitive networking (TSN) capable system 100 constructed according to the IEC/IEEE 60802 TSN profile. In the example of FIG. 1, the TSN capable system 100 includes example end stations 102A-102I, an example TSN capable network infrastructure 104, and example network management entities 106. In the example of FIG. 1, the end stations 102A-102I are devices that produce and/or consume data in the TSN capable system 100 but the end stations 102A-102I do not route or switch network traffic in the TSN capable system 100. In some examples, an end station may be referred to as a producer and/or a consumer depending on whether the end station produces and/or consumes data.

In the illustrated example of FIG. 1, the end stations 102A-102I allow various applications to communicate through the TSN capable network infrastructure 104 which includes multiple wired and/or wireless bridges as described herein. In the example of FIG. 1, the end station 102A is a programmable logic controller (PLC) and the end station 102B is an industrial personal computer (PC). In some examples, a single physical device may implement multiple end stations. For example, the end stations 102C-102E are implemented in example virtual execution environments (VEEs) 108A-108C executed on an example host device 110.

In the illustrated example of FIG. 1, the host device 110 is a server (e.g., an edge computing server) in a data center (e.g., an edge data center) and the end stations 102C-102E arc virtual devices. In examples disclosed herein, a VEE refers to an isolated computing environment that emulates a complete or partial system to execute software independently from the underlying physical hardware of a host device. VEEs abstract physical resources of a host device (e.g., central processor unit (CPU) core(s), memory, storage, network interface(s), etc.). In examples disclosed herein, VEEs include virtual machines (VMs) and containers.

In the illustrated example of FIG. 1, the end stations 102F, 102G and the end stations 102H, 102I are devices such as sensors or actuators with wireless connectivity. In the example of FIG. 1, the end stations 102F, 102G have cellular connectivity. For example, the end stations 102F, 102G (e.g., 5G connectivity). In the example of FIG. 1, the end stations 102H, 102I have wireless local area network (WLAN) connectivity. For example, the end stations 102H, 102I have Wi-Fi connectivity. In some examples, one or more of the end stations 102A-102I is network interface circuitry such as an Ethernet network interface card (NIC), a Wi-Fi NIC, or a cellular modem.

As described above, in the example of FIG. 1, the TSN capable network infrastructure 104 includes multiple wired and/or wireless bridges to facilitate communication. For example, the TSN capable network infrastructure 104 includes example local area network (LAN) bridges 112A-112D, an example virtual cellular bridge 114, and an example wireless local area network (WLAN) bridge 116. In the example of FIG. 1, the LAN bridges 112A-112D, the virtual cellular bridge 114, and the WLAN bridge 116 are devices that forward network traffic in the TSN capable system 100. In some examples, one or more of the LAN bridges 112A-112D, the virtual cellular bridge 114, or the WLAN bridge 116 includes added capabilities to provide predictable, low-latency, and reliable communication such as time-aware scheduling, time synchronization, traffic shaping and policing, stream reservation and management, and/or redundancy and fault tolerance.

In the illustrated example of FIG. 1, one or more of the LAN bridges 112A-112D are ethernet switches or ethernet routers. In the example of FIG. 1, the virtual cellular bridge 114 is a cellular base station such as Evolved Universal Terrestrial Radio Access (E-UTRA) Node B (eNodeB), a Next Generation Node B (gNodeB), etc.). Also, the WLAN bridge 116 is a Wi-Fi switch or Wi-Fi router. In the example of FIG. 1, the LAN bridge 112A is in communication with the LAN bridges 112B, 112C and the virtual cellular bridge 114 via wired connections. In the example of FIG. 1, the LAN bridge 112B is in communication with the LAN bridges 112A, 112D and the WLAN bridge 116 via wired connections. Also, the LAN bridge 112C is in communication with the LAN bridges 112A, 112D via wired connections and the LAN bridge 112D is in communication with the LAN bridges 112B, 112C via wired connections.

In the illustrated example of FIG. 1, the end stations 102A, 102B, and the host device 110 are in communication with the TSN capable network infrastructure 104 via a wired connection. For example, the end stations 102A, 102B, and the host device 110 are in communication with one or more of the LAN bridges 112A-112D. In the example of FIG. 1, the end stations 102F, 102G are in communication with the TSN capable network infrastructure 104 via a cellular connection. For example, the end stations 102F, 102G are in communication with the virtual cellular bridge 114. In the example of FIG. 1, the end stations 102H, 102I are in communication with the TSN capable network infrastructure 104 via a WLAN connection. For example, the end stations 102H, 102I are in communication with the WLAN bridge 116.

In the illustrated example of FIG. 1, the TSN capable system 100 includes the network management entities 106 to coordinate activity of each producer across the TSN capable system 100. In this manner, the TSN capable system 100 can achieve the required QoS for TSN applications. In general, TSN capabilities (e.g., time synchronization, time-aware scheduling, frame preemption, etc.) should be configured at end stations and bridges of the TSN capable system 100 to ensure low latency for time-sensitive traffic. In examples described herein, a system implementing a TSN application can be referred to as a TSN network or a time-sensitive network (TSN).

As described above, the TSN capable system 100 is implemented in accordance with the IEC/IEEE 60802 TSN profile which utilizes a centralized network configuration model defined in IEEE 802.1Qcc. As such, the network management entities 106 include an example centralized user configuration (CUC) manager 118 and an example centralized network configuration (CNC) manager 120 to manage resources of the TSN capable system 100. The IEC/IEEE 60802 TSN profile also defines TSN management entities for each device in the TSN capable system 100 and interactions between the devices and the network management entities 106.

In the illustrated example of FIG. 1, the CUC manager 118 is in communication with one or more of the end stations 102A-102I to discover which of the end stations 102A-102I are producers and which of the end stations 102A-102I are consumers. The IEC/IEEE 60802 TSN profile describes standard interfaces for communication between the CUC manager 118 and the end stations 102A-102I. In the example of FIG. 1, the CUC manager 118 is in communication with one or more of the end stations 102A-102I to discover TSN requirements of applications executed and/or instantiated by the end stations 102A-102I.

Example TSN requirements of applications include a number of TSN traffic flows to be communicated by producer end stations, latency and bandwidth requirements for respective TSN traffic flows, and synchronization requirements of respective TSN traffic flows. The IEC/IEEE 60802 TSN profile includes specification for the exchange of TSN requirements between applications and the CUC manager 118. In the example of FIG. 1, the CUC manager 118 is also in communication with the CNC manager 120 to request resources (e.g., bandwidth and scheduling slots) and to coordinate setup of TSN traffic streams across the TSN capable system 100.

In the illustrated example of FIG. 1, the CNC manager 120 is in communication with the CUC manager 118 to access requests including TSN requirements. The CNC manager 120 is also in communication with one or more of the LAN bridges 112A-112D, the virtual cellular bridge 114, or the WLAN bridge 116 to discover TSN capabilities of the LAN bridges 112A-112D, the virtual cellular bridge 114, and the WLAN bridge 116. The IEC/IEEE 60802 TSN profile includes standard interfaces for communication between the CNC manager 120, the LAN bridges 112A-112D, the virtual cellular bridge 114, and the WLAN bridge 116. In the example of FIG. 1, the CNC manager 120 evaluates the TSN capabilities of the LAN bridges 112A-112D, the virtual cellular bridge 114, and the WLAN bridge 116 as well as the TSN requirements for requests to establish TSN traffic streams in the TSN capable system 100.

Based on the evaluation, the CNC manager 120 calculates routing paths through the TSN capable system 100 for the TSN traffic streams. In the example of FIG. 1, if a requested TSN traffic stream is supportable by the TSN capable system 100, the CNC manager 120 configures one or more of the LAN bridges 112A-112D, the virtual cellular bridge 114, or the WLAN bridge 116 with scheduling, shaping, and reservation details to support the TSN traffic stream. Additionally, if a requested TSN traffic stream is supportable by the TSN capable system 100, the CNC manager 120 notifies the CUC manager 118 that the requested TSN traffic stream was accepted and provides the CUC manager 118 with a QoS configuration indicating how producer and/or consumer end stations associated with the TSN traffic stream are to be configured. The CUC manager 118 provides the producer and/or consumer end stations with the QoS configurations.

As described above, the TSN capable system 100 includes multiple end-stations (e.g., the end stations 102C-102E) running in VEEs (e.g., the VEEs 108A-108C) on the host device 110. Virtualization is a technology that allows for multiple workloads to be aggregated on a single, powerful host device. Virtualization allows physical equipment (e.g., servers, storage devices, network connections, etc.) to be separated from logical systems where a given workload is running. Virtualization also allows multiple workloads running on the same host device to be separated from each other. As such, virtualization offers multiple benefits including cost reduction, higher availability, easier maintenance, and easier upgrade, among others.

Several technologies, such as single root input/output (I/O) virtualization (SR-IOV) and virtualization technology for directed I/O (VT-d), provide efficient support for virtualization. SR-IOV allows multiple virtual functions (VF) to be exposed by the same hardware host device. Each VF can operate independently and can be assigned to a separate VEE running on the host device. From the perspective of each instance of an operating system (OS) that controls a VF, the OS controls an independent hardware device. Virtualization is very popular in data centers, both installed on-premise and by cloud service providers (CSPs).

In addition to data centers, virtualization can be implemented in other use cases such as industrial automation. In general, industrial automation is achieved using proprietary equipment that is dedicated to a particular task. In an industrial automation application, virtualization allows for multiple controllers, managing different elements of industrial process, to be aggregated on the same host device such as an edge-based server. In an industrial automation application, virtualization also allows controlled devices, originally located at the factory floor, to be decoupled from the controllers. In an industrial application, virtualization facilitates reduced operational costs, offers better protection against external conditions (e.g., pollution or vibrations), and simplifies maintenance.

Virtualization techniques for data centers are optimized for performance and costs, for example, to maximize the amount of transferred data and to reduce the number of resources needed to transfer the data. Transmission of data from multiple VMs is determined by both (1) VM scheduling controlled by the hypervisor and (2) traffic arbitration implemented in NICs. As such, traffic from multiple VMs observed on the wire is semi-random, with arbitrary latency and jitter. Similar traffic patterns are observed when implementing containers. As virtualization techniques for data centers are optimized for general-purpose network traffic, virtualization techniques for data centers do not consider requirements of TSN traffic such as minimizing latency for each network packet or preserving a fixed interval between cyclic real-time packets.

While the IEC/IEEE 60802 TSN profile was developed to drive adoption of TSN in industrial automation, the IEC/IEEE 60802 TSN profile assumes each end station is a separate device connected by a TSN network. However, virtualization allows for multiple instances of an end station to run on the same host device where each end station performs separate operations and maintains separate TSN traffic over the TSN network. Additionally, multiple end-stations running on the same host device can share the same network connection. Virtualization also assumes a certain level of flexibility in a network where the number of virtual instances can be changed over time and moved between host devices. As such, the aspects of virtualization should be taken into consideration when TSN traffic is planned.

Examples disclosed herein include a TSN system that addresses virtualization of end-stations in a flexible and scalable manner. For example, disclosed systems, methods, apparatus, and articles of manufacture allow for a TSN capable system to be migrated to a virtualized model. Examples disclosed herein are described in the context of the IEC/IEEE 60802 TSN profile for industrial automation. Examples disclosed herein are also applicable to other TSN profiles and applications.

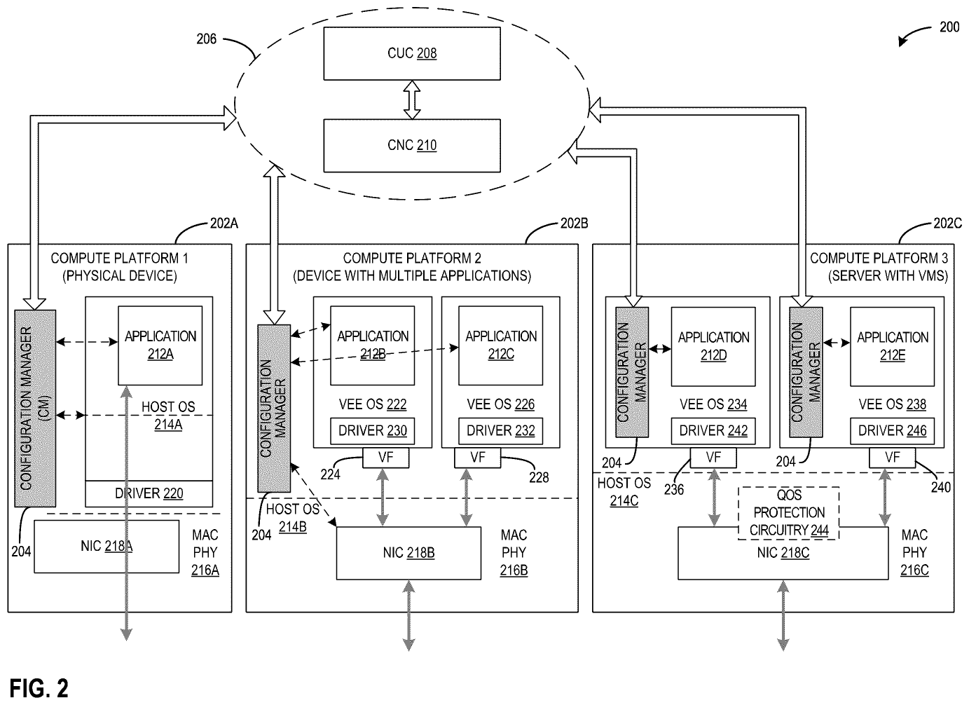

FIG. 2 is a block diagram of an example TSN capable system 200 where respective example compute platforms 202A-202C include at least one instance of example configuration manager (CM) circuitry 204. In the example of FIG. 1, the TSN capable system 200 includes example network management entities 206 to manage the compute platforms 202A-202C and, more generally, the TSN capable system 200. For example, the network management entities 206 include an example centralized user configuration (CUC) manager 208 and an example centralized network configuration (CNC) manager 210. In the example of FIG. 2, the CUC manager 208 is implemented similarly to the CUC manager 118 of FIG. 1 and the CNC manager 210 is implemented similarly to the CNC manager 120 of FIG. 1.

In the illustrated example of FIG. 2, each of the compute platforms 202A-202C includes at least one instance of the CM circuitry 204. In the example of FIG. 2, the CM circuitry 204 is implemented by programmable circuitry as described herein (e.g., at least one programmable circuit). Also, in the example of FIG. 2, the compute platforms 202A-202C are similar to one or more of the end stations 102A-102I or the host device 110 of FIG. 1. For example, the compute platform 202A is a physical device such as a PLC, a robotic controller, a human-machine interface (HMI), a motion control system, a sensor, or an actuator, among others. In the example of FIG. 2, the compute platform 202B is a physical device executing multiple applications. The example compute platform 202C of FIG. 2 is a server. As illustrated in FIG. 2, the compute platforms 202A-202C are implemented in three different ways.

For example, the first compute platform 202A implements a single application (e.g., example application 212A) and a first instance of the CM circuitry 204. In the example of FIG. 2, the application 212A is executed within an example host OS 214A of the compute platform 202A. The CM circuitry 204 of the compute platform 202A communicates with the application 212A to determine TSN requirements for TSN traffic streams requested by the application 212A. In the example of FIG. 2, the CM circuitry 204 of the compute platform 202A communicates the TSN requirements to the CUC manager 208 and/or the CNC manager 210. Based on the TSN requirements, the CUC manager 208 and/or the CNC manager 210 generates a QoS configuration for the application 212A.

In the illustrated example of FIG. 2, the CM circuitry 204 of the compute platform 202A configures TSN capabilities of the compute platform 202A based on the QoS configuration. For example, the compute platform 202A includes example media access control (MAC) physical layer (PHY) circuitry 216A such as example network interface circuitry (NIC) 218A that has configurable TSN capabilities. Additionally, an example driver 220 between the application 212A and the MAC PHY circuitry 216A can be adjusted to facilitate TSN requirements of the application 212A.

In the illustrated example of FIG. 2, the second compute platform 202B is dedicated for TSN tasks and implements more than one application (e.g., example application 212B and example application 212C). In the example of FIG. 2, the compute platform 202B has an example host OS 214B and example MAC PHY circuitry 216B such as example NIC 218B. In the example of FIG. 2, the host OS 214B includes an example VEE OS 222 executing the application 212B. For example, the application 212B utilizes an example VF 224 of the compute platform 202B. In the example of FIG. 2, the host OS 214B also includes an example VEE OS 226 executing the application 212C. For example, the application 212C utilizes an example VF 228 of the compute platform 202B.

In the illustrated example of FIG. 2, the compute platform 202B implements a second instance of the CM circuitry 204 that manages TSN traffic streams from all applications (e.g., the application 212B and the application 212C) executed on the compute platform 202B. That is, the single instance of the CM circuitry 204 of the compute platform 202B fully controls the entirety of the compute platform 202B based on a QoS configuration received from the CUC manager 208 and/or the CNC manager 210. For example, the CM circuitry 204 of the compute platform 202B communicates with the application 212B and the application 212C to determine respective TSN requirements for TSN traffic streams requested by the application 212B and the application 212C. Based on the respective time-sensitive networking requirements of the application 212B and the application 212C, the CM circuitry 204 of the compute platform 202B generates combined TSN requirements for the compute platform 202B.

In the illustrated example of FIG. 2, the CM circuitry 204 of the compute platform 202B communicates the combined TSN requirements to the CUC manager 208 and/or the CNC manager 210. Based on the combined TSN requirements, the CUC manager 208 and/or the CNC manager 210 generates a QoS configuration for the compute platform 202B and communicates the QoS configuration to the CM circuitry 204 of the compute platform 202B. In the example of FIG. 2, the CM circuitry 204 of the compute platform 202B configures TSN capabilities of the MAC PHY circuitry 216B and/or the NIC 218B based on the QoS configuration. Additionally, based on the QoS configuration, the CM circuitry 204 of the compute platform 202B adjusts an example driver 230 between the application 212B and the VF 224 as well as an example driver 232 between the application 212C and the VF 228.

In the illustrated example of FIG. 2, the third compute platform 202C implements multiple independent VMs each executing an application (e.g., example application 212D and example application 212E). In the example of FIG. 2, the compute platform 202C has an example host OS 214C and example MAC PHY circuitry 216C such as example NIC 218C. As described above, the compute platform 202C implements multiple independent VMs. For example, the host OS 214C includes an example VEE OS 234 executing the application 212D that utilizes an example VF 236 of the compute platform 202C. In the example of FIG. 2, the host OS 214C also includes an example VEE OS 238 executing the application 212E that utilizes an example VF 240 of the compute platform 202C.

In the illustrated example of FIG. 2, the VEE OS 234 implements a third instance of the CM circuitry 204 and the VEE OS 238 implements a fourth instance of the CM circuitry 204. In the example of FIG. 2, the CM circuitry 204 of the VEE OS 234 manages TSN traffic streams from the application 212D and the CM circuitry 204 of the VEE OS 238 manages TSN traffic streams from the application 212E. For example, the CM circuitry 204 of the VEE OS 234 communicates with the application 212D to determine TSN requirements for TSN traffic streams requested by the application 212D. Additionally, the CM circuitry 204 of the VEE OS 234 communicates the TSN requirements for the application 212D to the CUC manager 208 and/or the CNC manager 210.

Based on the TSN requirements of the application 212D, the CUC manager 208 and/or the CNC manager 210 generates a QoS configuration for the application 212D and communicates the QoS configuration to the CM circuitry 204 of the VEE OS 234. In the example of FIG. 2, the CM circuitry 204 of the VEE OS 238 communicates with the application 212E to determine TSN requirements for TSN traffic streams requested by the application 212E. In the example of FIG. 2, the CM circuitry 204 of the VEE OS 238 communicates the TSN requirements for the application 212E to the CUC manager 208 and/or the CNC manager 210. Based on the TSN requirements of the application 212E, the CUC manager 208 and/or the CNC manager 210 generates a QoS configuration for the application 212E and communicates the QoS configuration to the CM circuitry 204 of the VEE OS 238. For example, the QoS configurations provided by the CUC manager 208 and/or the CNC manager 210 are coordinated with one another to avoid conflicts (e.g., the QoS configurations include respective schedules that are non-overlapping).

Based on the respective QoS configurations, the two instances of the CM circuitry 204 generate respective configurations for respective data paths between the applications 212D, 212E and the interface circuitry of the compute platform 202C (e.g., the MAC PHY circuitry 216C). For example, the CM circuitry 204 of the VEE OS 234 generates a candidate configuration for the compute platform 202C based on the QoS configuration for the application 212D. That is, the CM circuitry 204 of the VEE OS 234 generates a candidate configuration to adjust TSN capabilities of the MAC PHY circuitry 216C and/or the NIC 218C as well as to adjust an example driver 242 between the application 212D and the VF 236. Also, for example, the CM circuitry 204 of the VEE OS 238 generates a candidate configuration for the compute platform 202C based on the QoS configuration for the application 212E. That is, the CM circuitry 204 of the VEE OS 238 generates a candidate configuration to adjust TSN capabilities of the MAC PHY circuitry 216C and/or the NIC 218C as well as to adjust an example driver 246 between the application 212E and the VF 240.

In the illustrated example of FIG. 2, the CM circuitry 204 of the VEE OS 234 and the CM circuitry 204 of the VEE OS 238 provide the candidate configurations to example QoS protection circuitry 244 of the NIC 218C. In the example of FIG. 2, the QoS protection circuitry 244 is implemented by programmable circuitry as described herein (e.g., at least one programmable circuit). In the example of FIG. 2, the QoS protection circuitry 244 determines whether the candidate configurations provided by the CM circuitry 204 of the VEE OS 234 and the CM circuitry 204 of the VEE OS 238 interfere with one another. Additionally, the QoS protection circuitry 244 determines whether the candidate configurations provided by the CM circuitry 204 of the VEE OS 234 and the CM circuitry 204 of the VEE OS 238 satisfy respective schedules included in the QoS configurations for the application 212D and the application 212E.

In the illustrated example of FIG. 2, if the candidate configurations do not interfere and the candidate configurations satisfy the respective schedules for the applications 212D and the application 212E, the QoS protection circuitry 244 permits the CM circuitry 204 of the VEE OS 234 and the CM circuitry 204 of the VEE OS 238 to configure the compute platform 202C. If either the candidate configurations interfere or at least one of the candidate configurations does not satisfy the respective schedules for the applications 212D and the application 212E, the QoS protection circuitry 244 notifies the CM circuitry 204 of the VEE OS 234 and the CM circuitry 204 of the VEE OS 238 that the candidate configurations were not accepted.

In the illustrated example of FIG. 2, if the candidate configurations were not accepted, the CM circuitry 204 of the VEE OS 234 and the CM circuitry 204 of the VEE OS 238 alerts the CUC manager 208 and/or the CNC manager 210 that the candidate configurations were not accepted. Based on the alerts, the CUC manager 208 and/or the CNC manager 210 provides updated QoS configurations to the CM circuitry 204 of the VEE OS 234 and the CM circuitry 204 of the VEE OS 238 for the application 212D and the application 212E, respectively. Based on the updated QoS configurations, the CM circuitry 204 of the VEE OS 234 and the CM circuitry 204 of the VEE OS 238 generate updated candidate configurations for the application 212D and the application 212E, respectively. In the example of FIG. 2, the QoS protection circuitry 244 verifies that the updated candidate configurations are non-interfering and that the updated candidate configurations satisfy the updated QoS configurations.

In some examples, the QoS protection circuitry 244 may be omitted. In such examples, it is assumed that configurations generated based on the QoS configuration for the application 212D and the QoS configuration for the application 212E (e.g., provided by the CUC manager 208 and/or the CNC manager 210) are non-interfering and that the configurations satisfy respective schedules included in the QoS configuration for the application 212D and the QoS configuration for the application 212E. Additionally, in such examples, the CM circuitry 204 of the VEE OS 234 configures the compute platform 202C based on reception of the QoS configuration for the application 212D. Also, in such examples, the CM circuitry 204 of the VEE OS 238 configures the compute platform 202C based on reception of the QoS configuration for the application 212E.

As described above, examples disclosed herein describe how virtualized and non-virtualized components of a TSN network are managed. Examples disclosed herein permit multiple TSN end stations to be run on the same host device in a virtualized environment. For example, disclosed examples permit two or more end stations (e.g., two end stations, three end stations, four end stations, etc.) to be run on the same host device (e.g., in separate VEEs managed by a single instance of the CM circuitry 204 or in separate VEEs managed by respective instances of the CM circuitry 204 implemented in each VEE). As such, applications that have not utilized virtualization, such as industrial automation, can be augmented to include virtualized components while still maintaining the requirements for TSN.

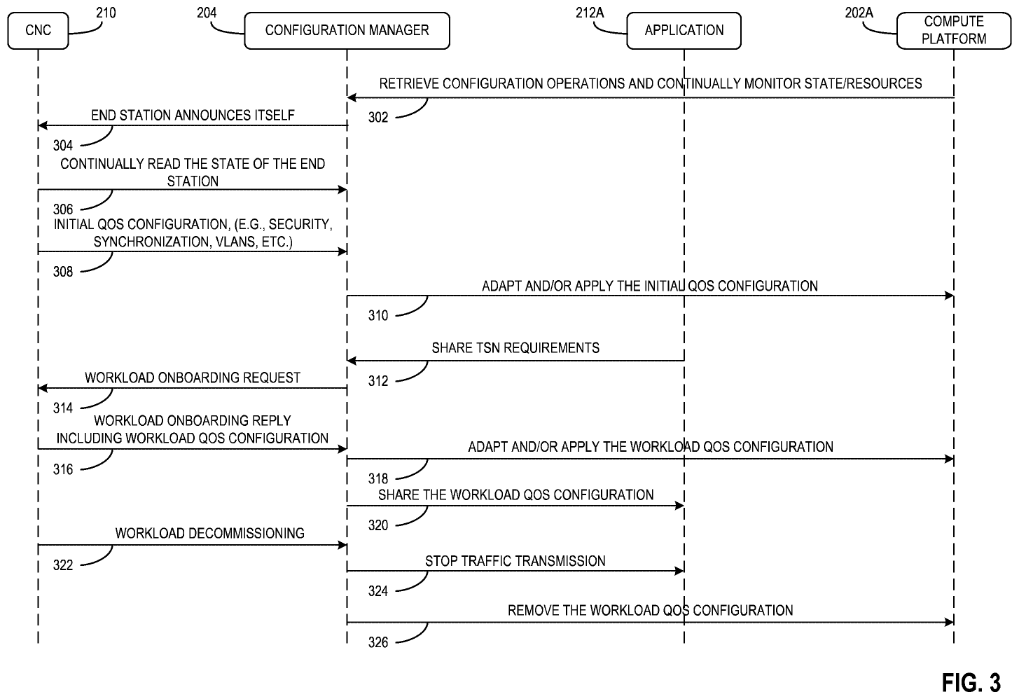

FIG. 3 is a sequence diagram illustrating example operations 300 of the TSN capable system 200 of FIG. 2. In the example of FIG. 3, at a first example operation 302, the CM circuitry 204 of the compute platform 202A retrieves configuration options from the compute platform 202A. For example, the CM circuitry 204 communicates with hardware (e.g., programmable circuitry, the MAC PHY circuitry 216A, the NIC 218A, etc.) and/or software (e.g., the host OS 214A) of the compute platform 202A to determine configuration options for the compute platform 202A (e.g., TSN capabilities supported by the compute platform 202A). In the example of FIG. 3, the CM circuitry 204 of the compute platform 202A continually monitors the state of the compute platform 202A and/or resources thereof.

Also, the CM circuitry 204 of the compute platform 202B retrieves configuration options from the compute platform 202B. For example, the CM circuitry 204 communicates with hardware (e.g., programmable circuitry, the MAC PHY circuitry 216B, the NIC 218B, etc.) and/or software (e.g., the host OS 214B, the VEE OS 222, the VF 224, the VEE OS 226, the VF 228, etc.) of the compute platform 202B to determine configuration options for the compute platform 202B. The CM circuitry 204 of the compute platform 202B continually monitors the state of the compute platform 202B and/or resources thereof.

Additionally, the CM circuitry 204 of the VEE OS 234 and the CM circuitry of the VEE OS 238 retrieve configuration options from the compute platform 202C. For example, the CM circuitry 204 of the VEE OS 234 communicates with hardware (e.g., programmable circuitry, the MAC PHY circuitry 216C, the NIC 218C, etc.) and/or software (e.g., the host OS 214C, the VEE OS 234, the VF 236, etc.) of the compute platform 202C to determine configuration options for the compute platform 202C. The CM circuitry 204 of the VEE OS 234 continually monitors the state of the compute platform 202C and/or resources thereof. Also, for example, the CM circuitry 204 of the VEE OS 238 communicates with hardware (e.g., programmable circuitry, the MAC PHY circuitry 216C, the NIC 218C, etc.) and/or software (e.g., the host OS 214C, the VEE OS 238, the VF 240, etc.) of the compute platform 202C to determine configuration options for the compute platform 202C. The CM circuitry 204 of the VEE OS 238 continually monitors the state of the compute platform 202C and/or resources thereof.

In the illustrated example of FIG. 3, at a second example operation 304, the CM circuitry 204 of the compute platform 202A announces the end station to the CNC manager 210. As the compute platform 202A implements one application (e.g., the application 212A), the CM circuitry 204 announces the compute platform 202A to the CNC manager 210 as the end station in the example of FIG. 3. For the compute platform 202B, the CM circuitry 204 is implemented at the platform-level. As such, the CM circuitry 204 of the compute platform 202B announces the VEE OS 222 and the VEE OS 226 to the CNC manager 210 as the end stations. For the compute platform 202C, the CM circuitry 204 of the VEE OS 234 announces the VEE OS 234 to the CNC manager 210 as an end station and the CM circuitry 204 of the VEE OS 238 announces the VEE OS 238 to the CNC manager 210 as an end station.

In the illustrated example of FIG. 3, at a third example operation 306, the CNC manager 210 continually reads the state of the compute platform 202A as reported by the CM circuitry 204 of the compute platform 202A. For the compute platform 202B, the CNC manager 210 continually reads the state of the VEE OS 222 and the state of the VEE OS 226 as reported by the CM circuitry 204 of the compute platform 202B. For the compute platform 202C, the CNC manager 210 continually reads the state of the VEE OS 234 as reported by the CM circuitry 204 of the VEE OS 234 and continually reads the state of the VEE OS 238 as reported by the CM circuitry 204 of the VEE OS 238.

In examples disclosed herein, continual operation indicates that an operation is performed once or multiple times over time. For example, continual operation includes the CNC manager 210 reading the state of an end-station (e.g., physical or virtual) once every 10 milliseconds (ms). In additional or alternative examples, continual operation includes the CNC manager 210 reading the state of an end-station once every minute. In some examples, continual operation includes the CNC manager 210 reading the state of an end-station at a different frequency (e.g., more frequently than once every 10 ms, less frequently than once every minute, etc.).

In the illustrated example of FIG. 3, at a fourth example operation 308, the CNC manager 210 provides an initial QoS configuration (e.g., for security, synchronization, virtual LANs (VLANs), etc.) to the CM circuitry 204 of the compute platform 202A. For the compute platform 202B, the CNC manager 210 provides, to the CM circuitry 204 of the compute platform 202B, an initial QoS configuration for the VEE OS 222 and an initial QoS configuration for the VEE OS 226. For the compute platform 202C, the CNC manager 210 provides an initial QoS configuration for the VEE OS 234 to the CM circuitry 204 of the VEE OS 234 and provides an initial QoS configuration for the VEE OS 238 to the CM circuitry 204 of the VEE OS 238.

In examples disclosed herein, an initial QoS configuration includes information specifying how traffic classes are mapped to egress queues of a compute platform and a gate control list (GCL) for the compute platform (if the compute platform uses time-aware shaping). Additionally or alternatively, an initial QoS configuration includes information specifying time synchronization parameters (e.g., the role of a compute platform (as a producer or consumer), a clock identity, a configuration for participating in a time synchronization protocol of a TSN capable network, etc.), ingress policing and shaping rules (e.g., rate limits, burst sizes, filter actions, etc.), and VLAN and priority code point (PCP) settings (e.g., a VLAN identifier (ID), a PCP value, etc.). An initial QoS configuration for an end station can include additional or alternative information.

In the illustrated example of FIG. 3, at a fifth example operation 310, the CM circuitry 204 of the compute platform 202A adapts and/or applies the initial QoS configuration to the compute platform 202A. For example, the CM circuitry 204 adjusts the host OS 214A, the MAC PHY circuitry 216A, the NIC 218A, and/or the driver 220 of the compute platform 202A to set initial values according to the initial QoS configuration. In the example of FIG. 3, the initial QoS configuration includes information to onboard the end station (e.g., the compute platform 202A) with the TSN capable system 200.

Additionally, the CM circuitry 204 of the compute platform 202B adapts and/or applies the initial QoS configuration for the VEE OS 222 to the compute platform 202B and adapts and/or applies the initial QoS configuration for the VEE OS 226 to the compute platform 202B. For example, the CM circuitry 204 of the compute platform 202B adjusts the host OS 214B, the MAC PHY circuitry 216B, and/or the NIC 218B to set initial values according to the initial QoS configuration for the VEE OS 222 and/or the initial QoS configuration for the VEE OS 226. Also, for example, the CM circuitry 204 of the compute platform 202B adjusts the VEE OS 222, the VF 224, and/or the driver 230 to set initial values according to the initial QoS configuration for the VEE OS 222. The CM circuitry 204 of the compute platform 202B also adjusts the VEE OS 226, the VF 228, and/or the driver 232 to set initial values according to the initial QoS configuration for the VEE OS 226.

For the compute platform 202C, the CM circuitry 204 of the VEE OS 234 adapts and/or applies the initial QoS configuration for the VEE OS 234 to the compute platform 202C. For example, the CM circuitry 204 of the VEE OS 234 adjusts the host OS 214C, the MAC PHY circuitry 216C, the NIC 218C, the VEE OS 234, the VF 236, and/or the driver 242 to set initial values according to the initial QoS configuration for the VEE OS 234. Additionally, the CM circuitry 204 of the VEE OS 238 adapts and/or applies the initial QoS configuration for the VEE OS 238 to the compute platform 202C. For example, the CM circuitry 204 of the VEE OS 238 adjusts the host OS 214C, the MAC PHY circuitry 216C, the NIC 218C, the VEE OS 238, the VF 240, and/or the driver 246 to set initial values according to the initial QoS configuration for the VEE OS 238. As described above, the QoS protection circuitry 244 may reject conflicting QoS configurations set by the CM circuitry 204 of the VEE OS 234 and the CM circuitry 204 of the VEE OS 238.

In the illustrated example of FIG. 3, at a sixth example operation 312, the CM circuitry 204 of the compute platform 202A communicates with the application 212A to determine TSN requirements for the application 212A. For the compute platform 202B, the CM circuitry 204 of the compute platform 202B communicates with the application 212B and the application 212C to determine TSN requirements for the application 212B and TSN requirements for the application 212C. For the compute platform 202C, the CM circuitry 204 of the VEE OS 234 communicates with the application 212D to determine TSN requirements for the application 212D. Also, the CM circuitry 204 of the VEE OS 238 communicates with the application 212E to determine TSN requirements for the application 212E.

In examples disclosed herein, example TSN requirements for an application include traffic characteristics of traffic to be communicated by the application, timing and latency requirements for the traffic, reliability requirements for the traffic, traffic classification parameters for the traffic, a requested QoS type for the traffic, and a scope and lifecycle for the traffic. Example traffic characteristics for an application include a data rate or bandwidth of traffic to be communicated by the application, a maximum frame size of the traffic, a transmission period for the traffic, a maximum burst size for the traffic, and directionality of the traffic (e.g., unicast, multicast, broadcast, producer/consumer roles, etc.). Example timing and latency requirements for an application include maximum end-to-end latency for traffic to be communicated by the application, jitter tolerance for the traffic, required synchronization accuracy for the traffic, and a deadline requirement for the traffic (e.g., “must arrive within 1 millisecond of transmission”).

Example reliability requirements for an application include a redundancy mode for traffic to be communicated by the application (e.g., single path, dual path, etc.) and frame loss tolerance (e.g., no loss tolerated, permitted to drop 1% of packets, etc.). Example traffic classification parameters for an application include a VLAN ID for traffic to be communicated by the application, a priority or PCP value for the traffic, a destination address (e.g., MAC address, IP address, etc.) for the traffic, a source address (e.g., MAC address IP address, etc.), and layer 4 port numbers for the traffic. Example QoS types for traffic to be communicated by an application include scheduled traffic (e.g., requires precise transmission time slots), frame preemption (e.g., used for mixing critical and best-effort traffic), stream reservation (e.g., requires bandwidth reservation, but not scheduled transmission time slots), and best-effort traffic (e.g., does not require bandwidth reservation or scheduled transmission time slots).

Example scope and lifecycle for traffic to be communication by an application include duration, activation time, and reconfigurability. Duration indicates how long a traffic stream is expected to be active. Activation time indicates when a traffic stream should begin (e.g., immediate, scheduled, etc.). Reconfigurability indicates whether an application may update parameters at a later time (e.g., to increase a bandwidth requirement).

In the illustrated example of FIG. 3, at a seventh example operation 314, the CM circuitry 204 of the compute platform 202A communicates a workload onboarding request to the CNC manager 210. In the example of FIG. 3, the workload onboarding request includes the TSN requirements of the application 212A. For the compute platform 202B, the CM circuitry 204 generates combined TSN requirements (also referred to as common TSN requirements) for the application 212B and the application 212C. As two applications are implemented on the compute platform 202B, the CM circuitry 204 compares the TSN requirements of the application 212B and the TSN requirements of the application 212C.

Based on the comparison, the CM circuitry 204 of the compute platform 202B determines common TSN requirements for the compute platform 202B. The common TSN requirements for the compute platform 202B satisfy both the TSN requirements of the application 212B and the TSN requirements of the application 212C (e.g., a common denominator). For example, if each of the application 212B and the application 212C requires different cycle times, the CM circuitry 204 determines a common cycle time that can be used for both the application 212B and the application 212C. Also for example, the CM circuitry 204 determines how to divide the available bandwidth of the compute platform 202B between the required bandwidth of the application 212B and the application 212C.

The CM circuitry 204 of the compute platform 202B communicates a workload onboarding request to the CNC manager 210 where the workload onboarding request includes the combined TSN requirements for the compute platform 202B. For the compute platform 202C, the CM circuitry 204 of the VEE OS 234 communicates a workload onboarding request to the CNC manager 210. For example, the workload onboarding request includes the TSN requirements of the application 212D. Also, the CM circuitry 204 of the VEE OS 238 communicates a workload onboarding request to the CNC manager 210. For example, the workload onboarding request includes the TSN requirements of the application 212E.

In the illustrated example of FIG. 3, at an eighth example operation 316, the CNC manager 210 communicates a workload onboarding reply to the CM circuitry 204 of the compute platform 202A. In the example of FIG. 3, the workload onboarding reply includes a workload QoS configuration for the application 212A. In examples disclosed herein, a workload QoS configuration includes information specifying a traffic specification for traffic to be communicated by an application, a stream identification for the traffic, packet marking rules for the traffic, per-stream filtering and policing controls for the traffic, GCL association and transmission timing for the traffic, preemption eligibility for the traffic, a redundancy configuration for the traffic, and reservation parameters for the traffic.

An example traffic specification for traffic to be communicated by an application includes a traffic class of the traffic, a data rate or bandwidth of the traffic, a burst size for the traffic, and QoS metrics for the traffic such as a maximum permissible latency for the traffic and a jitter tolerance for the traffic. An example stream identification for traffic to be communicated by an application includes a stream ID for the traffic, a destination address (e.g., MAC address, IP address, etc.) for the traffic, a VLAN ID and PCP value for the traffic, and a layer 2/3/4 tuple of port numbers for the traffic. Example packet marking rules for traffic to be communicated by an application includes a PCP value and/or a differentiated services code point (DSCP) value assigned to the traffic. Example per-stream filtering and policing (PSFP) controls for traffic to be communicated by an application includes rate limits for the traffic, drop policies for the traffic, and gate control enforcement policies (e.g., flow-specific ingress controls) for the traffic.

Example GCL association and transmission timing for traffic to be communicated by an application includes a schedule for the traffic (e.g., when the application is allowed or expected to transmit) and time slots (e.g., gate open/close window) in the schedule for transmission of the traffic. For example, a schedule defines a periodic interval during which an application is allowed or expected to transmit traffic. Example preemption eligibility includes whether traffic to be communicated by an application is eligible for frame preemption. An example redundancy configuration for traffic to be communicated by an application includes whether frame replication and elimination are enabled for the traffic. Example reservation parameters for traffic to be communicated by an application include reservation of bandwidth and queue resources along an end-to-end path of the traffic. A workload QoS configuration can include additional or alternative information.

For the compute platform 202B, the CNC manager 210 communicates a workload onboarding reply to the CM circuitry 204 of the compute platform 202B. As the CM circuitry 204 of the compute platform 202B communicated combined TSN requirements for the compute platform 202B, the workload onboarding reply includes a workload QoS configuration for the compute platform 202B. For the compute platform 202C, the CNC manager 210 communicates a workload onboarding reply to the CM circuitry 204 of the VEE OS 234. For example, the workload onboarding reply includes a workload QoS configuration for the application 212D. The CNC manager 210 also communicates a workload onboarding reply to the CM circuitry 204 of the VEE OS 238. For example, the workload onboarding reply includes a workload QoS configuration for the application 212E.

In the illustrated example of FIG. 3, at a ninth example operation 318, the CM circuitry 204 of the compute platform 202A adapts and/or applies the workload QoS configuration to the compute platform 202A. For example, the CM circuitry 204 adjusts the host OS 214A, the MAC PHY circuitry 216A, the NIC 218A, and/or the driver 220 of the compute platform 202A to set values according to the workload QoS configuration for the application 212A. In the example of FIG. 3, the CM circuitry 204 adjusts the host OS 214A, the MAC PHY circuitry 216A, the NIC 218A, and/or the driver 220 to establish a data path between the application 212A and the MAC PHY circuitry 216A that complies with the workload QoS configuration for the application 212A.

For the compute platform 202B, the CM circuitry 204 of the compute platform 202B generates respective configurations for each application implemented by the compute platform 202B based on the workload QoS configuration for the compute platform 202B (e.g., provided by the CNC manager 210). For example, based on the workload QoS configuration for the compute platform 202B, the CM circuitry 204 generates a first configuration for the application 212B and a second configuration for the application 212C. The CM circuitry 204 of the compute platform 202B adapts and/or applies the first configuration for the application 212B to the compute platform 202B and adapts and/or applies the second configuration for the application 212C to the compute platform 202B.

For example, the CM circuitry 204 of the compute platform 202B adjusts the host OS 214B, the MAC PHY circuitry 216B, and/or the NIC 218B to set values according to the first configuration for the application 212B and/or the second configuration for the application 212C. Also, for example, the CM circuitry 204 of the compute platform 202B adjusts the VEE OS 222, the VF 224, and/or the driver 230 to set values according to the first configuration for the application 212B. As such, the CM circuitry 204 adjusts the compute platform 202B to establish a first data path between the application 212B and the MAC PHY circuitry 216B that complies with the first configuration for the application 212B.The CM circuitry 204 of the compute platform 202B also adjusts the VEE OS 226, the VF 228, and/or the driver 232 to set values according to the second configuration for the application 212C. As such, the CM circuitry 204 adjusts the compute platform 202B to establish a second data path between the application 212C and the MAC PHY circuitry 216B that complies with the second configuration for the application 212C.

For the compute platform 202C, the CM circuitry 204 of the VEE OS 234 adapts and/or applies the workload QoS configuration for the application 212D to the compute platform 202C. For example, the CM circuitry 204 of the VEE OS 234 adjusts the host OS 214C, the MAC PHY circuitry 216C, the NIC 218C, the VEE OS 234, the VF 236, and/or the driver 242 to set values according to the workload QoS configuration for the application 212D. As such, the CM circuitry 204 adjusts the compute platform 202C to establish a first data path between the application 212D and the MAC PHY circuitry 216C that complies with the workload QoS configuration for the application 212D.

Additionally, the CM circuitry 204 of the VEE OS 238 adapts and/or applies the workload QoS configuration for the application 212E to the compute platform 202C. For example, the CM circuitry 204 of the VEE OS 238 adjusts the host OS 214C, the MAC PHY circuitry 216C, the NIC 218C, the VEE OS 238, the VF 240, and/or the driver 246 to set values according to the workload QoS configuration for the application 212E. As such, the CM circuitry 204 adjusts the compute platform 202C to establish a second data path between the application 212E and the MAC PHY circuitry 216C that complies with the workload QoS configuration for the application 212E. As described above, the QoS protection circuitry 244 may reject conflicting QoS configurations set by the CM circuitry 204 of the VEE OS 234 and the CM circuitry 204 of the VEE OS 238.

In the illustrated example of FIG. 3, at a tenth example operation 320, the CM circuitry 204 of the compute platform 202A shares the workload QoS configuration with the application 212A. For the compute platform 202B, the CM circuitry 204 of the compute platform 202B shares the first configuration with the application 212B and shares the second configuration with the application 212C. For the compute platform 202C, the CM circuitry 204 of the VEE OS 234 shares the workload QoS configuration for the application 212D with the application 212D. Also, the CM circuitry 204 of the VEE OS 238 shares the workload QoS configuration for the application 212E with the application 212E.

After the workload is completed (e.g., the traffic stream from the application 212A has completed), the CNC manager 210 communicates a workload decommissioning instruction to the CM circuitry 204 of the compute platform 202A at an eleventh example operation 322. For the compute platform 202B, when either a first workload (e.g., traffic stream) of the application 212B or a second workload (e.g., traffic stream) of the application 212C is completed, the CNC manager 210 communicates a workload decommissioning instruction to the CM circuitry 204 of the compute platform 202B. For the compute platform 202C, when a workload (e.g., traffic stream) of the application 212D is completed, the CNC manager 210 communicates a workload decommissioning instruction to the CM circuitry 204 of the VEE OS 234. Also, when a workload (e.g., traffic stream) of the application 212E is completed, the CNC manager 210 communicates a workload decommissioning instruction to the CM circuitry 204 of the VEE OS 238.

In the illustrated example of FIG. 3, at a twelfth example operation 324, the CM circuitry 204 of the compute platform 202A instructs the application 212A to stop transmission of the traffic in response to the decommissioning instruction. For the compute platform 202B, depending on the application(s) with which the decommissioning instruction is associated, the CM circuitry 204 of the compute platform 202B instructs the application 212B and/or the application 212C to stop transmission of traffic. For example, if the decommissioning instruction is associated with the application 212B, the CM circuitry 204 instructs the application 212B to stop transmission of traffic.

Also, for example, if the decommissioning instruction is associated with the application 212C, the CM circuitry 204 instructs the application 212C to stop transmission of traffic. For the compute platform 202C, the CM circuitry 204 of the VEE OS 234 instructs the application 212D to stop transmission of traffic in response to the decommissioning instruction. Also, the CM circuitry 204 of the VEE OS 238 instructs the application 212E to stop transmission of traffic in response to the decommissioning instruction.

In the illustrated example of FIG. 3, at a thirteenth example operation 326, the CM circuitry 204 of the compute platform 202A removes the workload QoS configuration for the application 212A from the compute platform 202A. For the compute platform 202B, the CM circuitry 204 of the compute platform 202B removes the first configuration for the application 212B from the compute platform 202B and removes the second configuration for the application 212C from the compute platform 202B. For the compute platform 202C, the CM circuitry 204 of the VEE OS 234 removes the workload QoS configuration for the application 212D from the compute platform 202C. Also, the CM circuitry 204 of the VEE OS 238 removes the workload QoS configuration for the application 212E from the compute platform 202C.

As described above, FIG. 3 illustrates interactions between the CM circuitry 204, the CNC manager 210, and components of the compute platform 202A. For example, the CM circuitry 204 directly communicates with the CNC manager 210 over interfaces described in the IEC/IEEE 60802 TSN profile. Within the compute platform 202A, the CM circuitry 204 communicates with hardware and/or software of the compute platform 202A as described herein. As such, examples disclosed herein resolve time-dependency in virtualized TSN networks.

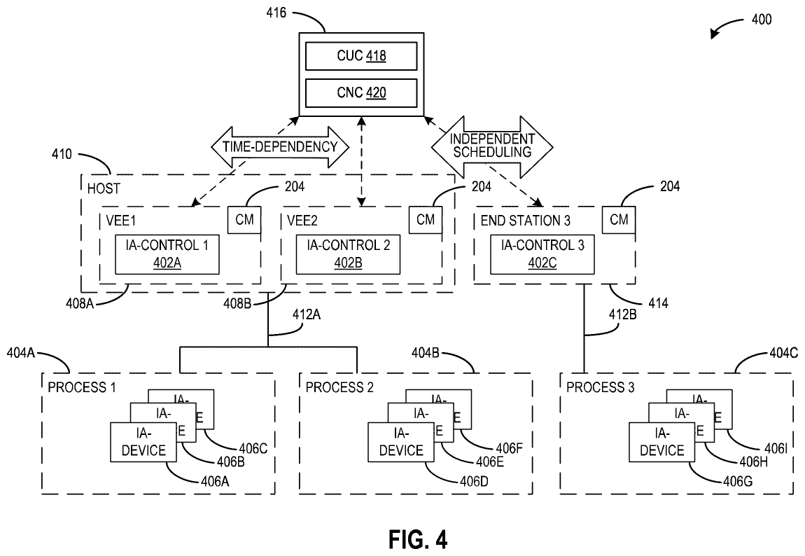

For example, FIG. 4 is a block diagram of an example TSN capable system 400 including three example industrial automation (IA) controllers 402A-402C managing three example industrial processes 404A-404C. Example industrial processes include automotive assembly, electronics production, packaging lines, chemical processing, oil refinement, power generation, and steel manufacturing, among others. In the example of FIG. 4, the industrial process 404A includes example IA devices 406A-406C, the industrial process 404B includes example IA devices 406D-406F, and the industrial process 404C includes example IA devices 406G-406I. Example IA devices include sensors, transducers, actuators, and robotic systems, among others.

In the illustrated example of FIG. 4, the IA controllers 402A, 402B are executed in example VEEs 408A, 408B, respectively, that each include an instance of the CM circuitry 204. As illustrated in FIG. 4, the VEEs 408A, 408B are collocated on an example host device 410 and as such, the IA controllers 402A, 402B share the same network interface. For example, the IA controllers 402A, 402B share an example network connection 412A. In the example of FIG. 4, the IA controller 402C runs on a dedicated example end-station 414 that includes an instance of the CM circuitry 204. In the example of FIG. 4, the IA controller 402C has a dedicated connection to the IA devices 406G-406I of the industrial process 404C that is managed by the IA controller 402C.

In the illustrated example of FIG. 4, the TSN capable system 400 also includes example network management entities 416. In the example of FIG. 4, the network management entities 416 include an example centralized user configuration (CUC) manager 418 and an example centralized network configuration (CNC) manager 420. In the example of FIG. 4, the CUC manager 418 is implemented similarly to the CUC manager 118 of FIG. 1 and the CNC manager 420 is implemented similarly to the CNC manager 120 of FIG. 1.

In the illustrated example of FIG. 4, because the IA controller 402C has an example dedicated network connection 412B to the industrial process 404C, the CNC manager 420 can schedule transmissions by the IA controller 402C independent of the other IA controllers (e.g., the IA controllers 402A, 402B). However, because the IA controllers 402A, 402B share the same network connection 412A, the CNC manager 420 should ensure that both of the IA controllers 402A, 402B do not attempt to transmit time-sensitive traffic at the same time. Advantageously, because the CM circuitry 204 of each of the VEEs 408A, 408B exposes the IA controllers 402A, 402B, respectively, to the CNC manager 420 as independent end stations, the CNC manager 420 can identify the IA controllers 402A, 402B as separate devices and schedule time-sensitive traffic accordingly.

As such, examples disclosed herein resolve time-dependency for applications running in VEEs, for example, utilizing dedicated CM circuitry. Thus, examples disclosed herein facilitate time-dependent scheduling by the network management entities 416 in virtualized environments without interrupting other operations defined by the IEC/IEEE 60802 TSN profile (e.g., the operation of the CNC manager 420). Accordingly, examples disclosed herein facilitate the integration of virtualization in industrial automation applications.

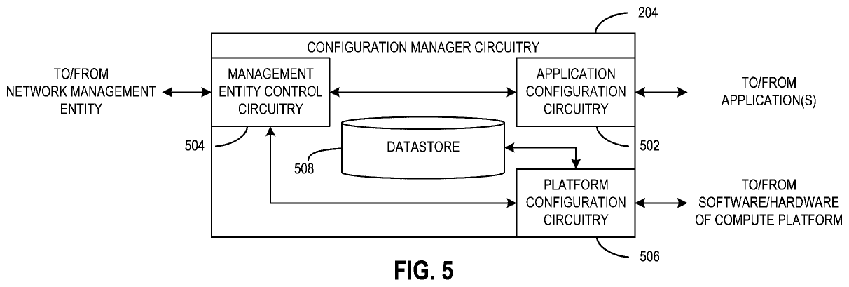

FIG. 5 is a block diagram of an example implementation of the CM circuitry 204 of FIG. 2. The CM circuitry 204 of FIG. 5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc.

Additionally or alternatively, the CM circuitry 204 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

In the illustrated example of FIG. 5, the CM circuitry 204 is a platform configurator that interacts with one or more applications implemented at a compute platform as well as one or more external network management entities (e.g., the CUC manager 208, the CNC manager 210). In the example of FIG. 5, the CM circuitry 204 configures both hardware and software features of the compute platform to define one or more data paths within the compute platform that is/are used by the one or more applications. In general, a data path includes a set of interfaces (or layers), stacked to handle network traffic in succession. Each interface receives input data from a preceding interface or an application, performs processing, and provides output data to a subsequent interface or the network. For a transmit data path, the first interface is the socket to which an application is writing data, and the last interface is the physical transmission media. As described above, time-sensitive traffic streams crossing a data path (e.g., for transmission or reception) require a certain QoS level associated with an application.

In the illustrated example of FIG. 5, the CM circuitry 204 configures standards-based features (e.g., TSN components) of the compute platform. Additionally or alternatively, the CM circuitry 204 configures proprietary features (e.g., features available only in platforms and/or NIC's provided by a specific manufacturer) of the compute platform. In such examples, the CM circuitry 204 includes specific APIs to configure proprietary hardware and/or software capabilities of the compute platform that may not be exposed to developers and/or users of the compute platform.

In some examples, the CM circuitry 204 is implemented for a specific compute platform and/or OS (e.g., a Linux-based platform). Additionally or alternatively, the CM circuitry 204 is implemented as general-purpose circuitry that supports multiple different platforms. In such examples, the CM circuitry 204 includes general-purpose circuitry and different platform-specific circuitry that implement platform-specific interfaces (e.g., for data path configuration). In some examples, the CM circuitry 204 is implemented as a development kit where each component of the CM circuitry 204 is implemented as a library in the development kit.

In the illustrated example of FIG. 5, the CM circuitry 204 acts as a configuration interface to attach a single or multiple applications to a TSN network and to configure respective data paths between the application(s) and a hardware network interface. The example CM circuitry 204 selects socket-based data path(s) optimized for low latency and attaches the socket-based data path(s) to application(s). The example CM circuitry 204 also prioritizes resources within a compute platform and configures NIC-specific features, including TSN features, to meet QoS requirements of application(s).

In the illustrated example of FIG. 5, the CM circuitry 204 includes example application configuration circuitry 502 to interact with the one or more applications implemented at a compute platform. The example CM circuitry 204 of FIG. 5 also includes example management entity control circuitry 504 to interact with one or more network management entities (e.g., the CUC manager 208, the CNC manager 210). For example, the management entity control circuitry 504 interfaces with the one or more network management entities via interface circuitry (e.g., one or more of the MAC PHY circuitry 216A, 216B, 216C). In the example of FIG. 5, the CM circuitry 204 includes example platform configuration circuitry 506 to coordinate local configuration of the compute platform for traffic stream(s) of the one or more applications resident on the compute platform.

In the illustrated example of FIG. 5, the CM circuitry 204 attaches one or more applications to a TSN network and configures one or more data paths between the one or more applications and the compute platform. In the example of FIG. 5, the application configuration circuitry 502 obtains TSN requirements from one or more applications implemented at the compute platform. For example, the application configuration circuitry 502 utilizes standard interfaces defined in the IEC/IEEE 60802 TSN profile and the IEEE 802.1Qcc standard and/or Linux APIs to communicate with the one or more applications. In the example of FIG. 5, the platform configuration circuitry 506 collects local platform configuration options from (e.g., TSN features supported by) a compute platform. For example, the platform configuration circuitry 506 utilizes standard interfaces defined in the IEC/IEEE 60802 TSN profile and the IEEE 802.1Qcc standard and/or Linux APIs to communicate with the compute platform.

In the illustrated example of FIG. 5, the management entity control circuitry 504 interacts with one or more network management entities via interface circuitry (e.g., one or more of the MAC PHY circuitry 216A, 216B, 216C). In the example of FIG. 5, the management entity control circuitry 504 interacts with the one or more network management entities to perform admission control and obtain a QoS configuration for an end station and/or a compute platform. For example, the management entity control circuitry 504 utilizes standard interfaces defined in the IEC/IEEE 60802 TSN profile and the IEEE 802.1Qcc standard to communicate with the one or more network management entities.

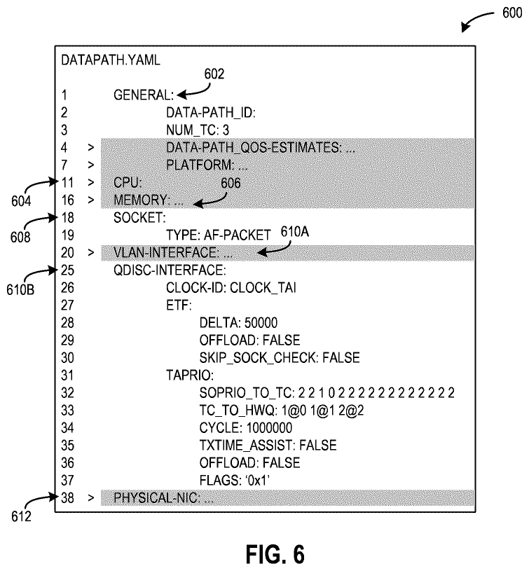

In the illustrated example of FIG. 5, the platform configuration circuitry 506 accesses one or more candidate data path templates for the compute platform. In the example of FIG. 5, the CM circuitry 204 includes an example datastore 508 to store the one or more candidate data path templates. For example, the datastore 508 includes a set of predefined data path templates where respective ones of the data path templates describe the structure of a single data path and provide an estimated QoS metric provided by that data path. FIG. 6 is a graphical illustration of an example data path template 600.

In the illustrated example of FIG. 6, the data path template 600 is defined in Yet Another Markup Language (YAML). In the example of FIG. 6, the data path template 600 specifies example general information 602 about the data path template 600, an example CPU configuration 604, an example memory configuration 606, an example socket configuration 608, example interface configurations 610A, 610B, and an example physical NIC configuration 612. The example general information 602 of the data path template 600 includes a data path ID, a number of traffic classes (TCs) supported by the data path template 600, and an estimated QoS metric for the data path template 600.

In the illustrated example of FIG. 6, the CPU configuration 604, the memory configuration 606, the socket configuration 608, and the physical NIC configuration 612 includes configurations for the CPU, the memory, the socket, and the physical NIC of a compute platform. For example, the socket configuration 608 specifies a socket type of the compute platform (e.g., an address family (AF) packet socket type). In the example of FIG. 6, the interface configurations 610A, 610B include configurations for one or more virtual interfaces of the compute platform. For example, the interface configuration 610A is a VLAN interface configuration and the interface configuration 610B is a queuing discipline (Qdisc) interface configuration.

In the illustrated example of FIG. 6, the interface configuration 610B includes a clock ID, an earliest transmission time first (ETF) configuration, and a time-aware priority (TAPRIO) configuration. An example ETF configuration includes a delta value to compensate for scheduling delays and Boolean values for whether offload and socket timestamp checking are utilized. An example TAPRIO configuration includes a mapping of socket option priority (SOPRIO) to TCs, a mapping of TCs to hardware egress queues, a cycle time, and Boolean values for whether transmit time assist and offload are utilized.

Returning to FIG. 5, the datastore 508 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 508 may additionally or alternatively be implemented by one or more double data rate (DDR) memories, such as DDR, DDR2, DDR3, DDR4, DDR5, mobile DDR (mDDR), DDR SDRAM, etc. The datastore 508 may additionally or alternatively be implemented by one or more mass storage devices such as hard disk drive(s) (HDD(s)), compact disk (CD) drive(s), digital versatile disk (DVD) drive(s), solid-state disk (SSD) drive(s), Secure Digital (SD) card(s), CompactFlash (CF) card(s), etc. While in the illustrated example the datastore 508 is illustrated as a single datastore, the datastore 508 may be implemented by any number and/or type(s) of datastores. Furthermore, the data stored in the datastore 508 may be in any data format such as, for example, binary data, comma delimited data, tab delimited data, YAML, structured query language (SQL) structures, etc.

In some examples, the datastore 508 also stores use-case profiles and profile specific candidate data paths. In the example of FIG. 5, one or more of the candidate data path templates are pre-installed in the datastore 508. In some examples, one or more of the candidate data path templates are configured in the datastore 508 at initialization of the CM circuitry 204. Additionally or alternatively, the application configuration circuitry 502 and/or the platform configuration circuitry 506 generate one or more of the candidate data path templates by inspecting application traffic and platform capabilities after initialization of the CM circuitry 204.

As described above, the platform configuration circuitry 506 accesses one or more candidate data path templates for the compute platform. In some examples, the platform configuration circuitry 506 accesses the one or more candidate data path templates in parallel with the management entity control circuitry 504 interacting with the one or more network management entities to onboard the one or more applications. In some examples, the platform configuration circuitry 506 does not access the one or more candidate data path templates (e.g., if the one or more candidate data path templates are pre-configured in the datastore 508 at an earlier time).

In the illustrated example of FIG. 5, after TSN requirements of one or more applications are retrieved and the one or more application is/are admitted to a TSN network (e.g., by the CUC manager 208, the CNC manager 210), the CM circuitry 204 selects one or more data paths for the one or more application and attaches the one or more data paths to the one or more applications. For example, the platform configuration circuitry 506 collects configuration options or tuning options of the compute platform. In the example of FIG. 5, the configuration options of the compute platform include information about the interfaces and tuning options available on the compute platform.

In the illustrated example of FIG. 5, the platform configuration circuitry 506 determines whether the compute platform includes interfaces and tuning options specified in the candidate data path templates. The example platform configuration circuitry 506 of FIG. 5 utilizes Linux APIs to collect the configuration options and/or tuning options of the compute platform. In the example of FIG. 5, the platform configuration circuitry 506 filters out any candidate data path templates that do not satisfy a QoS requirement associated with an application and/or that include configurations that are not feasible on the compute platform. For example, the platform configuration circuitry 506 compares the QoS requirement requested by an application and/or a network management entity to the QoS metrics included in the candidate data path templates.

In the illustrated example of FIG. 5, a QoS metric included in a candidate data path template is an estimated QoS metric that can be provided by the candidate data path template. In the example of FIG. 5, the platform configuration circuitry 506 eliminates candidate data path templates that include QoS metrics that do not satisfy the QoS metric required by the application and/or the network management entity. Additionally, the platform configuration circuitry 506 utilizes the configuration options of the compute platform to eliminate any candidate data path templates that are not feasible.

For example, if a candidate data path template is built for a kernel with certain capabilities that are unsupported by the compute platform, then the platform configuration circuitry 506 eliminates the candidate data path template from consideration. In the example of FIG. 5, the platform configuration circuitry 506 selects one or more data paths for one or more applications and configures the compute platform to establish the one or more data paths. For example, the platform configuration circuitry 506 selects one or more of the candidate data path templates remaining after filtering and applies the selected one or more data path templates to the compute platform as described by the selected one or more data path templates.

In the illustrated example of FIG. 5, the platform configuration circuitry 506 applies additional TSN configuration (e.g., as received from the one or more network management entities) to relevant components of the one or more data path (e.g., QDisc interface(s), available NIC(s), etc.). For example, the platform configuration circuitry 506 configures a transmission schedule in a Qdisc interface as well as any other parameters that are dynamically obtained from the one or more external network management entities. In some examples, the platform configuration circuitry 506 also configures proprietary options of the compute platform (e.g., if the compute platform includes proprietary options).

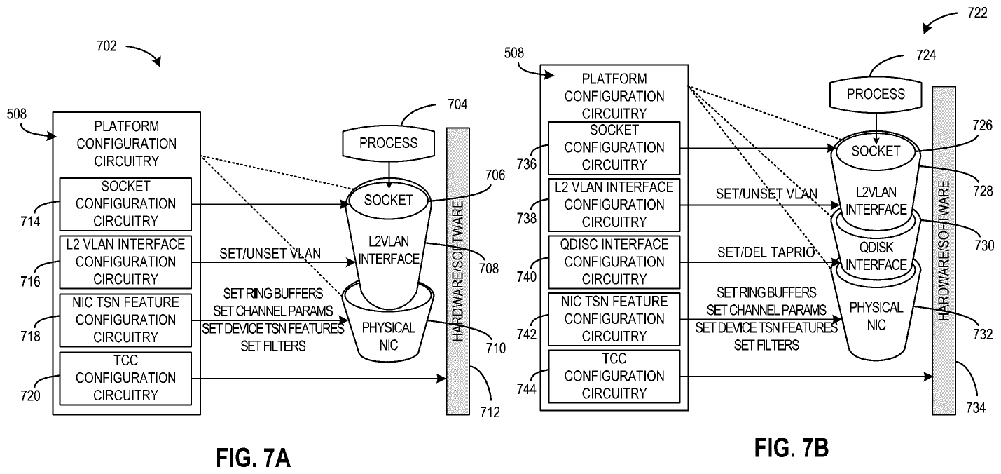

FIGS. 7A and 7B depict two example Linux-based data paths that may be utilized for time-critical applications. FIG. 7A is a block diagram of a first example data path 702. In the example of FIG. 7A, the data path 702 (e.g., based on an express data path) connects an example application process 704 to an example socket 706 which connects to an example layer 2 (L2) VLAN interface 708. Also, the L2 VLAN interface 708 connects to an example physical NIC 710. In the example of FIG. 7A, the socket 706, the L2 VLAN interface 708, and the physical NIC 710 are hardware and/or software components of an example compute platform 712. In the example of FIG. 7A, the platform configuration circuitry 506 can configure several settings and/or TSN features of the compute platform 712 to define the data path 702.

For example, the platform configuration circuitry 506 includes example socket configuration circuitry 714 to configure the socket 706. Additionally, the platform configuration circuitry 506 includes example L2 VLAN interface configuration circuitry 716 to configure the L2 VLAN interface 708. For example, the L2 VLAN interface configuration circuitry 716 can set or unset a VLAN ID for the L2 VLAN interface 708. In the example of FIG. 7A, the platform configuration circuitry 506 includes example NIC TSN feature configuration circuitry 718 to configure the physical NIC 710. For example, the NIC TSN feature configuration circuitry 718 can set ring buffers, set channel parameters, set TSN features, and set filters of the physical NIC 710. In the example of FIG. 7A, the platform configuration circuitry 506 includes example traffic class classifier (TCC) configuration circuitry 720 to configure a TCC of the compute platform 712.

FIG. 7B is a block diagram of a second example data path 722. In the example of FIG. 7B, the data path 722 (e.g., based on an AF packet) connects an example application process 724 to an example socket 726 which connects to an example L2 VLAN interface 728. Also, the L2 VLAN interface 728 connects to an example Qdisc interface 730 which connects to an example physical NIC 732. In the example of FIG. 7B, the socket 726, the L2 VLAN interface 728, the Qdisc interface 730, and the physical NIC 732 are hardware and/or software components of an example compute platform 734. In the example of FIG. 7B, the platform configuration circuitry 506 can configure several settings and/or TSN features of the compute platform 734 to define the data path 722. For example, the platform configuration circuitry 506 includes example socket configuration circuitry 736 to configure the socket 726.

Additionally, the platform configuration circuitry 506 includes example L2 VLAN interface configuration circuitry 738 to configure the L2 VLAN interface 728. For example, the L2 VLAN interface configuration circuitry 738 can set or unset a VLAN ID for the L2 VLAN interface 728. In the example of FIG. 7B, the platform configuration circuitry 506 includes example Qdisc interface configuration circuitry 740 to configure the Qdisc interface 730. For example, the Qdisc interface configuration circuitry 740 can set delta and TAPRIO values for the Qdisc interface 730. In the example of FIG. 7B, the platform configuration circuitry 506 includes example NIC TSN feature configuration circuitry 742 to configure the physical NIC 732. For example, the NIC TSN feature configuration circuitry 742 can set ring buffers, set channel parameters, set TSN features, and set filters of the physical NIC 732. In the example of FIG. 7B, the platform configuration circuitry 506 includes example TCC configuration circuitry 744 to configure a TCC of the compute platform 734.

As described above, the CM circuitry 204 facilitates the configuration of various features of a compute platform. Example configurations disclosed herein include several layers that form a data path connecting an application to physical transmission media of a compute platform to ensure deterministic low latency traffic for the application. For example, the CM circuitry 204 accesses a QoS configuration from one or more network management entities and maps the QoS configuration information to components (e.g., OS, driver, network interface circuitry, etc.) of a compute platform. Based on the mapping, the CM circuitry 204 defines a data path between the application and physical transmission media to ensure deterministic low latency traffic for the application.

Additionally, the CM circuitry 204 configures a compute platform to connect an application to a data path and include interfaces to configure the data path to provide the required QoS level for the application. As described above, the configuration of the compute platform defines one or more optimized data paths for one or more time-critical applications. In some examples, the CM circuitry 204 also manages additional time coordinated computing capabilities of a compute platform (e.g., cache allocation, core assignment and/or pining, etc.). Other data path options exist in examples disclosed herein.

As described in FIG. 2, one or multiple applications can be executed at the same compute platform. Regardless of the implementation, the CM circuitry 204 manages multiple possible deployments of the end station. As described herein, the problem of managing multiple applications deployed at the same host device can be translated to the problem of managing multiple data paths on the same host device. In non-virtualized environments (e.g., a platform-level instance of the CM circuitry 204 managing a single application), a data path is managed by the local instance of the CM circuitry 204. In deployments where virtualization is used to run more than one application on the same node, different options are possible.

For example, the CM circuitry 204 can be implemented at the platform level to manage multiple applications executed in separate VEEs. In this implementation, the CM circuitry 204 controls multiple applications and multiple instances of a data path running on the same hardware network interface. The single instance of the CM circuitry 204 controls hardware and network resources, for example, to ensure that two applications do not send real-time traffic at the same time. In this implementation, it is assumed that the CM circuitry 204 has complete control of the entire network interface and can communicate with all running real-time applications using TSN. In multi-application examples where each application utilizes a different data path in a compute platform, the CM circuitry 204 is responsible for the consistency of the compute platform. For example, the CM circuitry 204 ensures that the active data paths do not interfere with each other, and that the compute platform can continue to support the required control and/or management traffic (e.g., synchronization traffic and data traffic).

Also, for example, the CM circuitry 204 can be implemented at the VEE-level to manage respective applications executed in separate VEEs. For example, each instance of the CM circuitry 204 controls a local instance of the data path, controlled by the application executed in the same VEE. In this implementation, it is assumed that an application running in a VEE communicates with the instance of the CM circuitry 204 implemented in the VEE. Also, in this implementation, each data path can be implemented using SR-IOV and/or VFs exposed by the network interface hardware.

In this implementation, each application in a VEE is controlled independently and the central network management entity (e.g., the CNC manager 210) is responsible for ensuring that each application has a unique configuration that does not affect real-time traffic of other applications. As such, the central network management entity (e.g., the CNC manager 210) should understand that some applications share the same network interface and enforce limitations related to the shared network interface. For example, the CNC manager 210 should ensure that two applications sharing the same interface do not transmit real-time traffic at the same time. The CNC manager 210 can ensure non-overlapping transmissions of real-time traffic by allocating different transmission slots to each of the applications sharing the same interface.

In multi-application examples, colocation of the CM circuitry 204 and application in the same VEE allows for better scalability than a platform-level instance of the CM circuitry 204. For example, when collocated with an instance of the CM circuitry 204, each application continues to communicate with the collocated instance of the CM circuitry 204 as the TSN network scales. Thus, the interface for each application can be simpler and more efficient than when the CM circuitry 204 is implemented at the platform level. Additionally, all applications can run in fully independent VEEs (e.g., VMs, containers, etc.) and do not depend on each other.

As described above, examples where each application is collocated with an instance of the CM circuitry 204 allow for TSN networks to be more easily migrated from the bare-metal scenario (e.g., one application per compute platform) to the virtualization scenario (e.g., multiple application on a single host) than a platform-level instance of the CM circuitry 204. For example, when an instance of the CM circuitry 204 is collocated with each application, a TSN network can be migrated to the virtualization scenario without rewriting the application, the CNC manager 210, or the CM circuitry 204. Thus, examples where each application is collocated with an instance of the CM circuitry 204 offer better reliability than a platform-level instance of the CM circuitry 204 and allow applications to be migrated between different hosts.

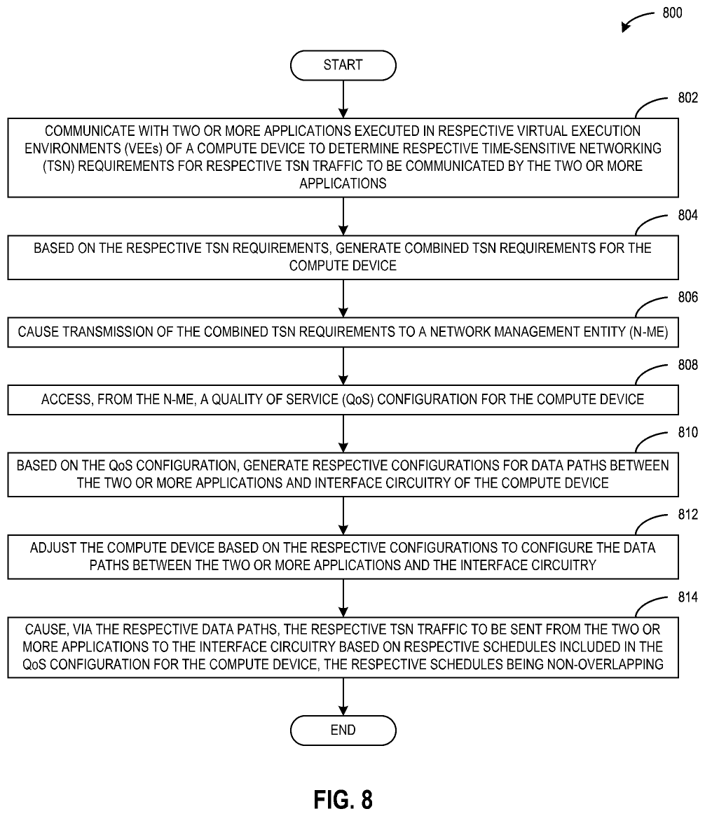

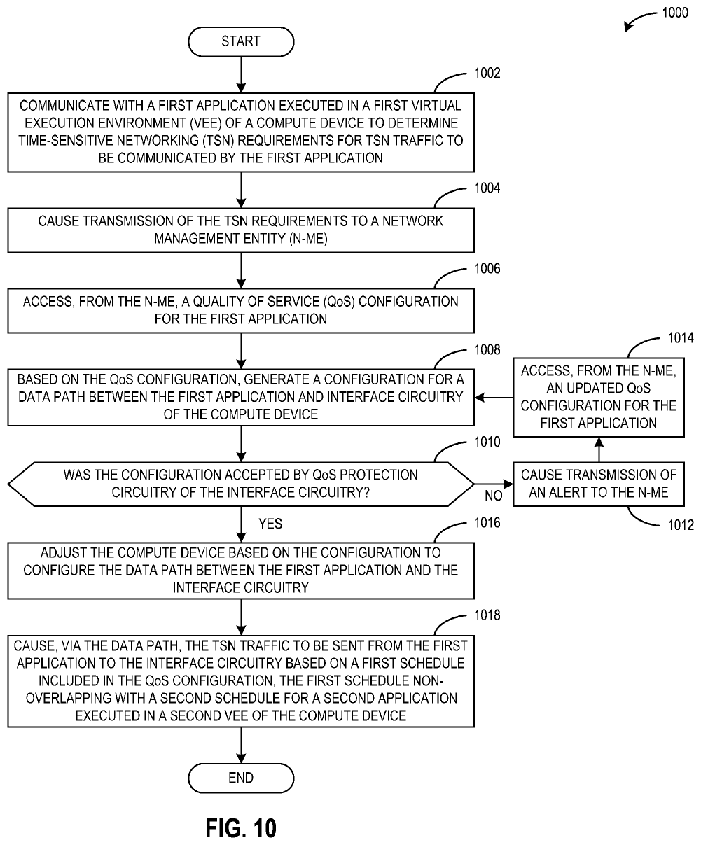

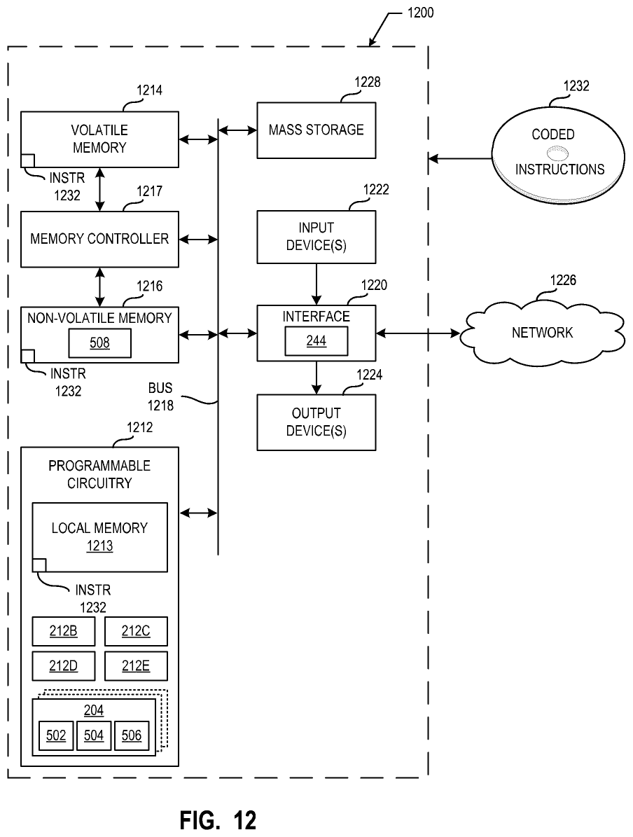

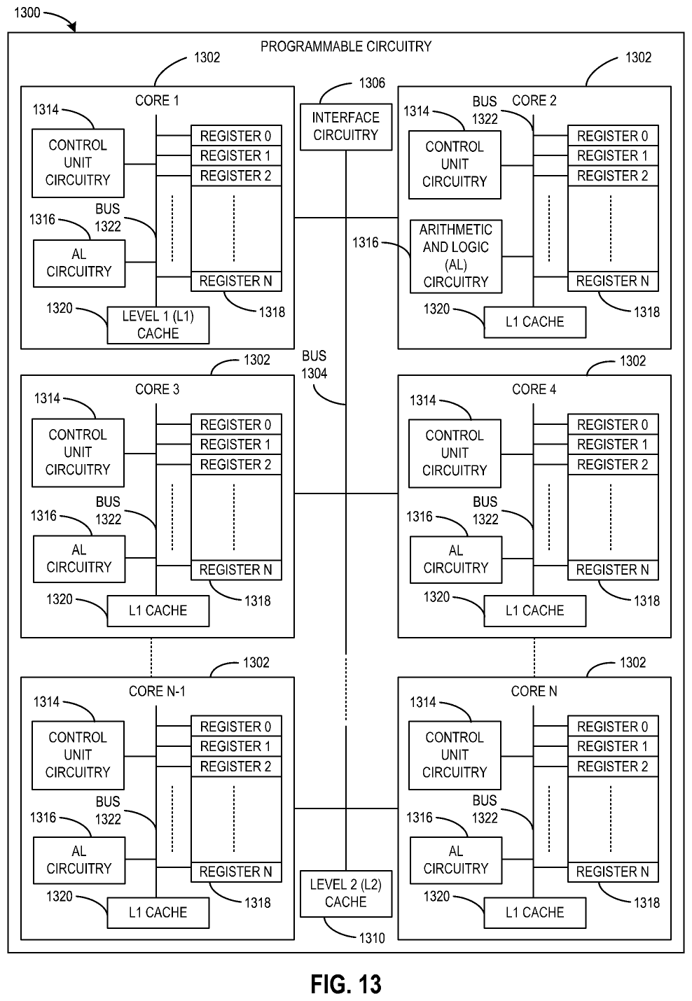

In some examples, the application configuration circuitry 502 is instantiated by programmable circuitry executing application configuration instructions and/or configured to perform operations such as those represented by the flowchart(s) of FIGS. 8 and 10. In some examples, the CM circuitry 204 includes means for configuring application(s). For example, the means for configuring may be implemented by the application configuration circuitry 502. In some examples, the application configuration circuitry 502 may be instantiated by programmable circuitry such as the example programmable circuitry 1212 of FIG. 12. For instance, the application configuration circuitry 502 may be instantiated by the example microprocessor 1300 of FIG. 13 executing machine-executable instructions such as those implemented by at least blocks 802 and 804 of FIG. 8 and at least block 1002 of FIG. 10.

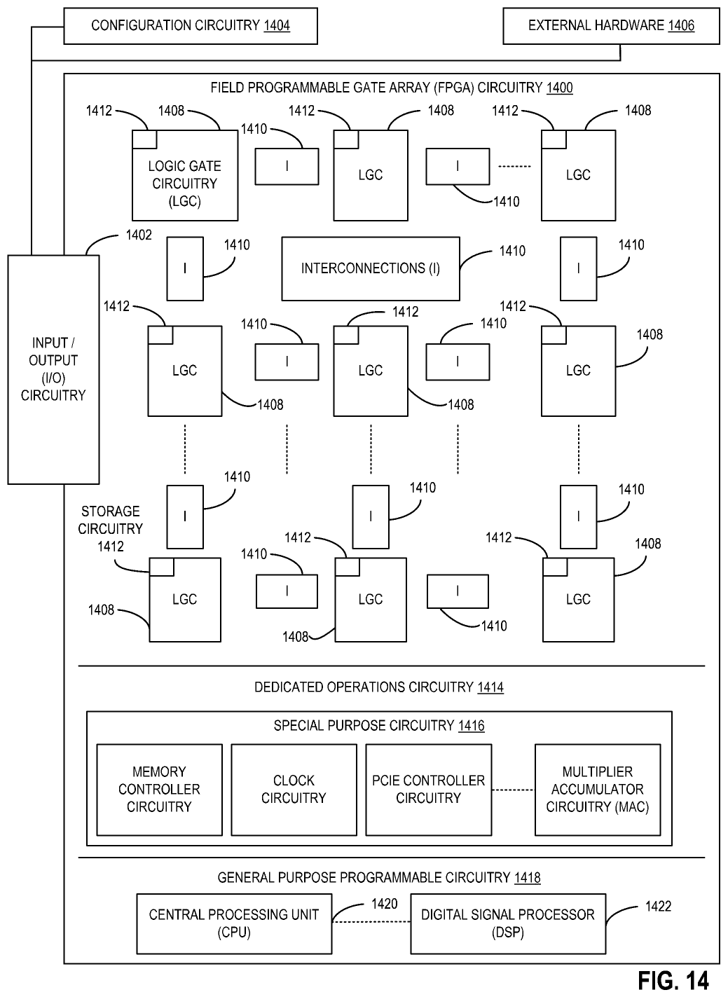

In some examples, the application configuration circuitry 502 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the application configuration circuitry 502 may be instantiated by any other combination of hardware, software, and/or firmware. For example, the application configuration circuitry 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the management entity control circuitry 504 is instantiated by programmable circuitry executing management entity control instructions and/or configured to perform operations such as those represented by the flowchart(s) of FIGS. 8 and 10. In some examples, the CM circuitry 204 includes means for controlling a compute device based on a management entity. For example, the means for controlling may be implemented by the management entity control circuitry 504. In some examples, the management entity control circuitry 504 may be instantiated by programmable circuitry such as the example programmable circuitry 1212 of FIG. 12. For instance, the management entity control circuitry 504 may be instantiated by the example microprocessor 1300 of FIG. 13 executing machine-executable instructions such as those implemented by at least blocks 806 and 808 of FIG. 8 and at least blocks 1004, 1006, 1012, and 1014 of FIG. 10.

In some examples, the management entity control circuitry 504 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the management entity control circuitry 504 may be instantiated by any other combination of hardware, software, and/or firmware. For example, the management entity control circuitry 504 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

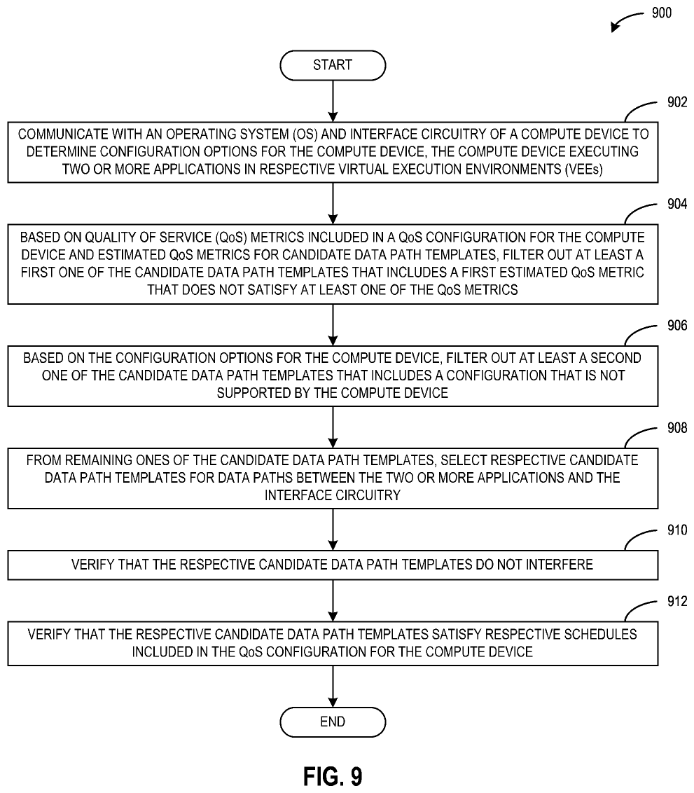

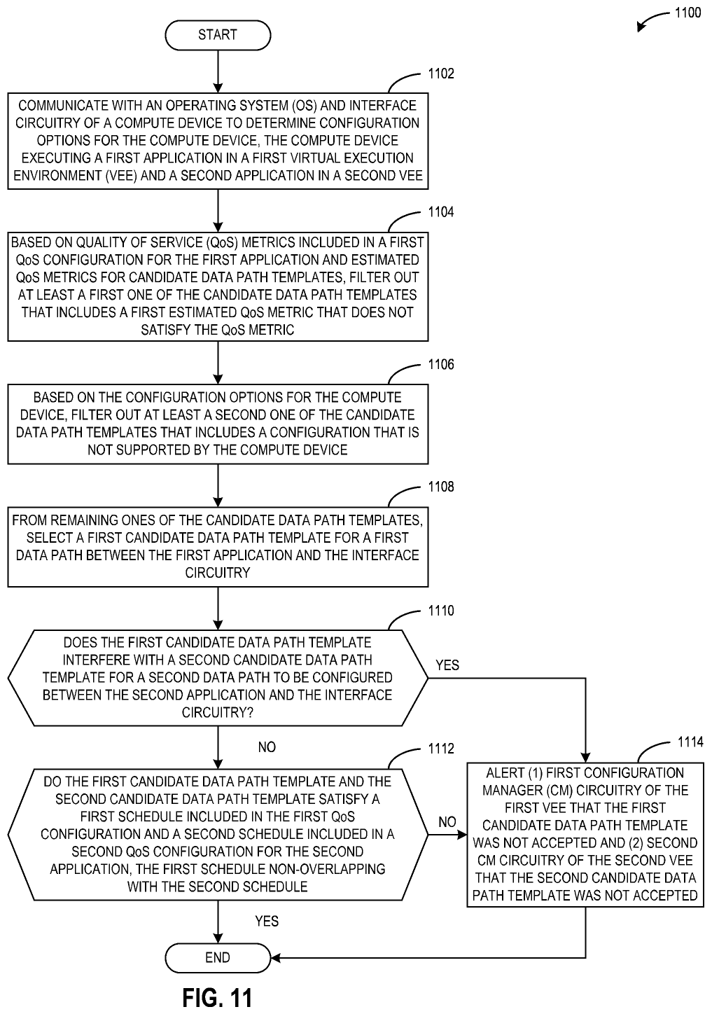

In some examples, the platform configuration circuitry 506 is instantiated by programmable circuitry executing platform configuration instructions and/or configured to perform operations such as those represented by the flowchart(s) of FIGS. 8, 9, 10, and 11. In some examples, the CM circuitry 204 includes means for configuring a compute device. For example, the means for configuring may be implemented by the platform configuration circuitry 506. In some examples, the platform configuration circuitry 506 may be instantiated by programmable circuitry such as the example programmable circuitry 1212 of FIG. 12. For instance, the platform configuration circuitry 506 may be instantiated by the example microprocessor 1300 of FIG. 13 executing machine-executable instructions such as those implemented by at least blocks 810 and 812 of FIG. 8, at least block 902, 904, 906, 908, 910, and 912 of FIG. 9, at least blocks 1008, 1010, and 1016 of FIG. 10, and at least blocks 1102, 1104, 1106, and 1108 of FIG. 11.

In some examples, the platform configuration circuitry 506 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the platform configuration circuitry 506 may be instantiated by any other combination of hardware, software, and/or firmware. For example, the platform configuration circuitry 506 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, at least one the VEE OSes 222, 226, 234, 238 is instantiated by programmable circuitry executing virtual execution environment instructions and/or configured to perform operations such as those represented by the flowchart(s) of FIGS. 8 and 10. In some examples, at least one of the compute platforms 202B, 202C includes means for virtually execution application(s). For example, the means for virtually executing may be implemented by at least one the VEE OSes 222, 226, 234, 238. In some examples, at least one the VEE OSes 222, 226, 234, 238 may be instantiated by programmable circuitry such as the example programmable circuitry 1212 of FIG. 12. For instance, at least one the VEE OSes 222, 226, 234, 238 may be instantiated by the example microprocessor 1300 of FIG. 13 executing machine-executable instructions such as those implemented by at least block 814 of FIG. 8 and at least block 1018 of FIG. 10.

In some examples, at least one the VEE OSes 222, 226, 234, 238 may be

instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, at least one the VEE OCes 222, 226, 234, 238 may be instantiated by any other combination of hardware, software, and/or firmware. For example, at least one the VEE OSes 222, 226, 234, 238 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the QoS protection circuitry 244 is instantiated by programmable circuitry executing QoS protection instructions and/or configured to perform operations such as those represented by the flowchart(s) of FIG. 11. In some examples, the compute platform 202C includes means for verifying data paths. For example, the means for verifying may be implemented by the QoS protection circuitry 244. In some examples, the QoS protection circuitry 244 may be instantiated by programmable circuitry such as the example programmable circuitry 1212 of FIG. 12. For instance, the QoS protection circuitry 244 may be instantiated by the example microprocessor 1300 of FIG. 13 executing machine-executable instructions such as those implemented by at least blocks 1110, 1112, and 1114 of FIG. 11.

In some examples, the QoS protection circuitry 244 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the QoS protection circuitry 244 may be instantiated by any other combination of hardware, software, and/or firmware. For example, the QoS protection circuitry 244 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the CM circuitry 204 of FIG. 2 is illustrated in FIG. 5, one or more of the elements, processes, and/or devices illustrated in FIG. 5 may be combined, divided, re-arranged, omitted, eliminated, and/or implemented in any other way. Further, the example application configuration circuitry 502, the example management entity control circuitry 504, the example platform configuration circuitry 506, the example datastore 508, and/or, more generally, the example CM circuitry 204 of FIG. 5 and/or the example QoS protection circuitry 244 of FIG. 2, may be implemented by hardware alone or by hardware in combination with software and/or firmware. Thus, for example, any of the example application configuration circuitry 502, the example management entity control circuitry 504, the example platform configuration circuitry 506, the example datastore 508, and/or, more generally, the example CM circuitry 204 and/or the example QoS protection circuitry 244, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s)

(FPLD(s)) such as FPGAs in combination with machine-readable instructions (e.g., firmware or software). Further still, the example CM circuitry 204 of FIG. 5 may include one or more elements, processes, and/or devices in addition to, or instead of, those illustrated in FIG. 5, and/or may include more than one of any or all of the illustrated elements, processes, and devices.

Flowchart(s) representative of example machine-readable instructions, which may be executed by programmable circuitry to implement and/or instantiate the CM circuitry 204 of FIG. 5 and/or the QoS protection circuitry 244 of FIG. 2 and/or representative of example operations which may be performed by programmable circuitry to implement and/or instantiate the CM circuitry 204 of FIG. 5 and/or the QoS protection circuitry 244 of FIG. 2, are shown in FIGS. 8, 9, 10, and/or 11. The machine-readable instructions may be one or more executable programs or portion(s) of one or more executable programs for execution by programmable circuitry such as the programmable circuitry 1212 shown in the example programmable circuitry platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 8, 9, 10, and/or 11, many other methods of implementing the example CM circuitry 204 and/or the example QoS protection circuitry 244 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller unit (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks, and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable, and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), YAML, SQL, Swift, etc.

As mentioned above, the example operations of FIGS. 8, 9, 10, and/or 11 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic, and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 8 is a flowchart representative of example machine-readable instructions and/or example operations 800 that may be executed, instantiated, and/or performed by example programmable circuitry to implement the CM circuitry 204 of FIG. 5 at the compute platform level as illustrated in the compute platform 202B of FIG. 2. The example machine-readable instructions and/or the example operations 800 of FIG. 8 begin at block 802, at which the application configuration circuitry 502 communicates with two or more applications executed in respective VEEs of a compute device to determine respective TSN requirements for respective TSN traffic to be communicated by the two or more applications.

In the illustrated example of FIG. 8, at block 804, based on the respective TSN requirements, the application configuration circuitry 502 generates combined TSN requirements for the compute device. For example, the application configuration circuitry 502 compares the TSN requirements of the two or more applications and, based on the comparison, determines common TSN requirements for the compute device. In the example of FIG. 8, the common TSN requirements for the compute device satisfy the TSN requirements of the two or more applications (e.g., a common denominator). For example, if each of the two or more applications requires different cycle times, the application configuration circuitry 502 determines a common cycle time that can be used for each of the two or more applications. Also, for example, the application configuration circuitry 502 determines how to divide the available bandwidth of the compute device between the required bandwidth of the two or more applications.

In the illustrated example of FIG. 8, at block 806, the management entity control circuitry 504 causes transmission of the combined TSN requirements to a network management entity (e.g., the CNC manager 210). For example, the management entity control circuitry 504 is to cause transmission via interface circuitry of the compute device. In the example of FIG. 8, at block 808, the management entity control circuitry 504 accesses, from the network management entity, a QoS configuration for the compute device. For example, the management entity control circuitry 504 accesses the QoS configuration for the compute device via the interface circuitry of the compute device.

In the illustrated example of FIG. 8, at block 810, based on the QoS configuration, the platform configuration circuitry 506 generates respective configurations for data paths between the two or more applications and the interface circuitry of the compute device. For example, the platform configuration circuitry 506 evaluates the QoS configuration for the compute device and the TSN requirements for the two or more applications and generates respective configurations that satisfy the TSN requirements of the two or more applications. In the example of FIG. 8, at block 812, the platform configuration circuitry 506 adjusts the compute device based on the respective configurations to configure the data paths between the two or more applications and the interface circuitry.

In the illustrated example of FIG. 8, at block 814, the respective VEEs of the compute device cause, via the respective data paths, the respective TSN traffic to be sent from the two or more applications to the interface circuitry based on respective schedules included in the QoS configuration for the compute device. For example, with reference to FIG. 2, the application 212B of the VEE OS 222 provides, via a first data path, TSN traffic to the MAC PHY circuitry 216B based on a first schedule included in a QoS configuration for the compute platform 202B. Also, for example, with reference to FIG. 2, the application 212C of the VEE OS 226 provides, via a second data path, TSN traffic to the MAC PHY circuitry 216B based on a second scheduled included in the QoS configuration for the compute platform 202B. In the example of FIG. 8, the respective schedules of the two or more applications are non-overlapping.

FIG. 9 is a flowchart representative of example machine-readable instructions and/or example operations 900 that may be executed, instantiated, and/or performed by example programmable circuitry to generate respective configurations for data paths between two or more applications and interface circuitry when the CM circuitry 204 of FIG. 5 is implemented at the compute platform level. The example machine-readable instructions and/or the example operations 900 of FIG. 9 begin at block 902, at which the platform configuration circuitry 506 communicates with an OS and interface circuitry of a compute device to determine configuration options for the compute device. For example, the compute device executes two or more applications in respective VEEs.

In the illustrated example of FIG. 9, at block 904, based on QoS metrics included in a QoS configuration for the compute device and estimated QoS metrics for candidate data path templates, the platform configuration circuitry 506 filters out at least a first one of the candidate data path templates that includes a first estimated QoS metric that does not satisfy at least one of the QoS metrics. For example, the QoS configuration for the compute device includes respective quality of service metrics (e.g., maximum permissible latency, jitter tolerance, etc.) for the two or more applications. Based on respective QoS metrics (e.g., based on respective quality of service metrics) of the QoS configuration and the estimated QoS metrics for the candidate data path templates, the platform configuration circuitry 506 filters out at least a first one of the candidate data path templates. For example, the filtered-out candidate data path template includes a first estimated QoS metric that does not satisfy at least one of the QoS metrics.

In the illustrated example of FIG. 9, at block 906, based on configuration options for the compute device, the platform configuration circuitry 506 filters out at least a second one of the candidate data path templates that includes a configuration that is not supported by the compute device. In the example of FIG. 9, at block 908, from the remaining ones of the candidate data path templates, the platform configuration circuitry 506 selects respective candidate data path templates for data paths between the two or more applications and the interface circuitry. At block 910, the platform configuration circuitry 506 verifies that the respective candidate data path templates do not interfere.

In the illustrated example of FIG. 9, at block 912, the platform configuration circuitry 506 verifies that the respective candidate data path templates satisfy respective schedules included in the QoS configuration for the compute device. In the example of FIG. 9, if the platform configuration circuitry 506 determines that one or more of the data paths do not pass verification, then the management entity control circuitry 504 notifies a network management entity (e.g., the CNC manager 210) that the QoS configuration for the compute device is not valid. For example, the network management entity can provide an updated QoS configuration in response to the notification. In some examples, blocks 910 and 912 are omitted on the assumption that the network management entity performs verification.

FIG. 10 is a flowchart representative of example machine-readable instructions and/or example operations 1000 that may be executed, instantiated, and/or performed by example programmable circuitry to implement the CM circuitry 204 of FIG. 5 at the VEE level as illustrated in the compute platform 202C of FIG. 2. The example machine-readable instructions and/or the example operations 1000 of FIG. 10 begin at block 1002, at which the application configuration circuitry 502 communicates with a first application executed in a first VEE of a compute device to determine TSN requirements for TSN traffic to be communicated by the first application. At block 1004, the management entity control circuitry 504 causes transmission of the TSN requirements to a network management entity (e.g., the CNC manager 210). For example, the management entity control circuitry 504 is to cause transmission via interface circuitry of the compute device.

In the illustrated example of FIG. 10, at block 1006, the management entity control circuitry 504 accesses, from the network management entity, a QoS configuration for the first application. For example, the management entity control circuitry 504 accesses the QoS configuration for the first application via the interface circuitry of the compute device. At block 1008, based on the QoS configuration, the platform configuration circuitry 506 generates a configuration for a data path between the first application and the interface circuitry of the compute device. Subsequently, the platform configuration circuitry 506 provides the configuration to the QoS protection circuitry 244.

In the illustrated example of FIG. 10, at block 1010, the platform configuration circuitry 506 determines whether the configuration was accepted by the QoS protection circuitry 244 of the interface circuitry. Based on (e.g., in response to) the platform configuration circuitry 506 determining that the configuration was not accepted (block 1010: NO), the machine-readable instructions and/or the operations 1000 proceed to block 1012. At block 1012, the management entity control circuitry 504 causes transmission of an alert to the network management entity. At block 1014, the management entity control circuitry 504 accesses, from the network management entity, an updated QoS configuration for the first application.

Returning to block 1010, based on (e.g., in response to) the platform configuration circuitry 506 determining that the configuration was accepted (block 1010: YES), the machine-readable instructions and/or the operations 1000 proceed to block 1016. In the example of FIG. 10, at block 1016, the platform configuration circuitry 506 adjusts the compute device based on the configuration to configure the data path between the first application and the interface circuitry. At block 1018, the first VEE causes, via the data path, the TSN traffic to be sent from the first application to the interface circuitry based on a first schedule included in the QoS configuration for the first application. For example, the first schedule is non-overlapping with a second schedule for a second application executed in a second VEE of the compute device (e.g., respective schedules being non-overlapping).

As described above, the machine-readable instructions and/or the operations 1000 may be executed, instantiated, and/or performed by programmable circuitry to implement the CM circuitry 204 of FIG. 5 at the VEE level. Thus, the configurations generated by each instance of the CM circuitry 204, per VEE, are coordinated to avoid interference with the QoS protection circuitry 244 verifying that the configurations do not interfere. In some examples, blocks 1010, 1012, and 1014 and the QoS protection circuitry 244 are omitted on the assumption that the network management entity performs verification.

FIG. 11 is a flowchart representative of example machine-readable instructions and/or example operations 1100 that may be executed, instantiated, and/or performed by example programmable circuitry to generate respective configurations for data paths between two or more applications and interface circuitry when the CM circuitry 204 of FIG. 5 is implemented at the VEE level. The example machine-readable instructions and/or the example operations 1100 of FIG. 11 begin at block 1102, at which the platform configuration circuitry 506 communicates with an OS and interface circuitry of a compute device to determine configuration options for the compute device. For example, the compute device executes a first application in a first VEE and a second application in a second VEE.

In the illustrated example of FIG. 11, at block 1104, based on a QoS metric included in a QoS configuration for the first application and estimated QoS metrics for candidate data path templates, the platform configuration circuitry 506 filters out at least a first one of the candidate data path templates that includes a first estimated QoS metric that does not satisfy the QoS metric. At block 1106, based on the configuration options for the compute device, the platform configuration circuitry 506 filters out at least a second one of the candidate data path templates that includes a configuration that is not supported by the compute device. In the example of FIG. 11, at block 1108, from the remaining ones of the candidate data path templates, the platform configuration circuitry 506 selects a first candidate data path templates for a first data path between the first application and the interface circuitry.

In the illustrated example of FIG. 11, at block 1110, the QoS protection circuitry 244 determines whether the first candidate data path template interferes with a second candidate data path template for a second data path to be configured between the second application and the interface circuitry. Based on (e.g., in response to) the QoS protection circuitry 244 determining that the first candidate data path template interferes with the second candidate data path template (block 1110: YES), the machine-readable instructions and/or the operations 1100 proceed to block 1114. Based on (e.g., in response to) the QoS protection circuitry 244 determining that the first candidate data path template does not interfere with the second candidate data path template (block 1110: NO), the machine-readable instructions and/or the operations 1100 proceed to block 1112.

In the illustrated example of FIG. 11, at block 1112, the QoS protection circuitry 244 determines whether the first candidate data path template and the second candidate data path template satisfy a first schedule included in the first QoS configuration and a second schedule included in a second QoS configuration for the second application. For example, the first schedule is non-overlapping with the second schedule. Based on (e.g., in response to) the QoS protection circuitry 244 determining that the first candidate data path template and the second candidate data path template satisfy the first schedule and the second schedule (block 1112: YES), the machine-readable instructions and/or the operations 1100 terminate.

Based on (e.g., in response to) the QoS protection circuitry 244 determining that at least one of the first candidate data path template or the second candidate data path template does not satisfy at least one of the first schedule or the second schedule (block 1112: NO), the machine-readable instructions and/or the operations 1100 proceed to block 1114. At block 1114, the QoS protection circuitry 244 alerts a first instance of the CM circuitry 204 of the first VEE that the first candidate data path template was not accepted. Also, at block 1114, the QoS protection circuitry 244 alerts a second instance of the CM circuitry 204 of the second VEE that the second candidate data path template was not accepted.

As described above, the machine-readable instructions and/or the operations 1100 may be executed, instantiated, and/or performed by programmable circuitry when the CM circuitry 204 of FIG. 5 is implemented at the VEE level. Thus, the configurations generated by each instance of the CM circuitry 204, per VEE, are coordinated to avoid interference with the QoS protection circuitry 244 verifying that the configurations do not interfere. In some examples, blocks 1110, 1112, and 1114 and the QoS protection circuitry 244 are omitted on the assumption that the network management entity performs verification.

FIG. 12 is a block diagram of an example programmable circuitry platform 1200 structured to execute and/or instantiate the example machine-readable instructions and/or the example operations of FIGS. 8, 9, 10, and/or 11 to implement the CM circuitry 204 of FIG. 5 and/or the QoS protection circuitry 244 of FIG. 2. The programmable circuitry platform 1200 can be, for example, a server, a personal computer, a workstation, a self-learning machine (e.g., a neural network), a mobile device (e.g., a cell phone, a smart phone, a tablet such as an iPad™M), a personal digital assistant (PDA), an Internet appliance, a gaming console, a video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, VPUs, DSPs, and/or microcontrollers from any desired family or manufacturer. The programmable circuitry 1212 may be implemented by one or more semiconductor based (e.g., silicon based) devices. In this example, the programmable circuitry 1212 implements at least two example applications (e.g., the example applications 212C, 212C, 212D, 212E) and at least one instance of the example CM circuitry 204. For example, the example CM circuitry 204 includes the example application configuration circuitry 502, the example management entity control circuitry 504, and the example platform configuration circuitry 506.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. In this example, the non-volatile memory 1214 implements the example datastore 508. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc. In this example, the interface circuitry 1220 implements the example QoS protection circuitry 244.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1232, which may be implemented by the machine-readable instructions of FIGS. 8, 9, 10, and/or 11, may be stored in the mass storage device 1228, in the volatile memory 1214, in the non-volatile memory 1216, and/or on at least one non-transitory computer-readable storage medium such as a CD or DVD which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 8, 9, 10, and/or 11 to effectively instantiate the circuitry of FIGS. 2 and/or 5 as logic circuits to perform operations corresponding to those machine-readable instructions. In some such examples, the circuitry of FIGS. 2 and/or 5 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine-readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine-readable instructions and/or operations represented by the flowcharts of FIGS. 8, 9, 10, and/or 11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (12C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry 1316 (sometimes referred to as an ALU), a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer-based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an 12C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine-readable instructions. However, once configured, the FPGA circuitry 1400 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine-readable instructions represented by the flowchart(s) of FIGS. 8, 9, 10, and/or 11 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 8, 9, 10, and/or 11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8, 9, 10, and/or 11. As such, the FPGA circuitry 1400 may be configured and/or structured to effectively instantiate some or all of the operations/functions corresponding to the machine-readable instructions of the flowchart(s) of FIGS. 8, 9, 10, and/or 11 as dedicated logic circuits to perform the operations/functions corresponding to those software instructions in a dedicated manner analogous to an ASIC. Therefore, the FPGA circuitry 1400 may perform the operations/functions corresponding to the some or all of the machine-readable instructions of FIGS. 8, 9, 10, and/or 11 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine-readable instructions of FIGS. 8, 9, 10, and/or 11 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine-readable instructions represented by the flowchart(s) of FIGS. 8, 9, 10, and/or 11 to perform first operation(s)/function(s), the FPGA circuitry 1400 of FIG. 14 may be configured and/or structured to perform second operation(s)/function(s) corresponding to a second portion of the machine-readable instructions represented by the flowcharts of FIGS. 8, 9, 10, and/or 11, and/or an ASIC may be configured and/or structured to perform third operation(s)/function(s) corresponding to a third portion of the machine-readable instructions represented by the flowcharts of FIGS. 8, 9, 10, and/or 11.

It should be understood that some or all of the circuitry of FIGS. 2 and/or 5 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIGS. 2 and/or 5 may be instantiated, for example, in one or more threads executing concurrently and/or in series. For example, the microprocessor 1300 of FIG. 13 may execute machine-readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIGS. 2 and/or 5 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

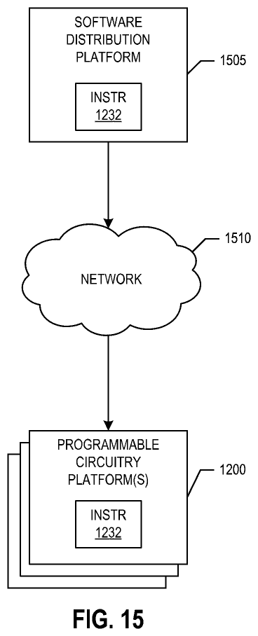

A block diagram illustrating an example software distribution platform 1505 to distribute software such as the example machine-readable instructions 1232 of FIG. 12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine-readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine-readable instructions 1232, which may correspond to the example machine-readable instructions of FIGS. 8, 9, 10, and/or 11, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1232 from the software distribution platform 1505. For example, the software, which may correspond to the example machine-readable instructions of FIGS. 8, 9, 10, and/or 11, may be downloaded to the example programmable circuitry platform 1200, which is to execute the machine-readable instructions 1232 to implement the CM circuitry 204 and/or the QoS protection circuitry 244. In some examples, one or more servers of the software distribution platform 1505 periodically offer, transmit, and/or force updates to the software (e.g., the example machine-readable instructions 1232 of FIG. 12) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein “real-time” refers to occurrence in a near instantaneous manner recognizing there may be real world delays for computing time, transmission, etc. Thus, unless otherwise specified, “real-time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that manage virtual end stations in TSN networks that are compliant with the IEC/IEEE 60802 TSN profile. As such, various types of the devices, including simple controllers on dedicated compute platforms, complex controllers on dedicated platform, and virtual controllers running on the universal host platform with virtualization, can be managed in a TSN network. Additionally, examples disclosed herein separate data path and other configurations of a platform from an application. As such, applications can easily be migrated between different platforms.

Example systems, apparatus, articles of manufacture, and methods disclosed herein permit the number of TSN applications running on a single compute platform to be scaled. Additionally, examples disclosed herein simplify TSN networking by utilizing a single instance of CM circuitry to manage multiple TSN applications that operate on the same, dedicated platform. Disclosed systems, apparatus, articles of manufacture, and methods also improve the efficiency of using a computing device by virtualizing compute devices in TSN applications.

For example, by virtualizing compute devices in TSN applications, examples disclosed herein can aggregate multiple controllers, managing different elements of a TSN application (e.g., an industrial process), to be aggregated on the same host device. Thus, controlled devices can be decoupled from controllers which reduces operational costs, offers better protection against external conditions (e.g., pollution or vibrations), and simplifies maintenance. Disclosed systems, apparatus, articles of manufacture, and methods are accordingly directed to one or more improvement(s) in the operation of a machine such as a computer or other electronic and/or mechanical device and/or a network.

Example methods, apparatus, systems, and articles of manufacture for virtual execution environments and interface circuitry in time-sensitive networking are disclosed herein. Further examples and combinations thereof include the following:

Example 1 includes a compute device comprising interface circuitry, machine-readable instructions, and at least one programmable circuit to be programmed by the machine-readable instructions to execute a first application for a time-sensitive network (TSN) in a first virtual execution environment (VEE), execute a second application for the TSN in a second VEE, cause first real-time traffic to be sent from the first application to the interface circuitry based on a first schedule, and cause second real-time traffic to be sent from the second application to the interface circuitry based on a second schedule such that transmission of the first real-time traffic does not occur at the same time as transmission of the second real-time traffic.

Example 2 includes the compute device of example 1, wherein one or more of the at least one programmable circuit is to, based on a quality of service configuration for the compute device, configure (1) a first data path between the first application and the interface circuitry and (2) a second data path between the second application and the interface circuitry.

Example 3 includes the compute device of any of examples 1 or 2, wherein one or more of the at least one programmable circuit is to, based on respective TSN requirements for the first application and the second application, generate combined TSN requirements for the compute device, and cause transmission of the combined TSN requirements to a network management entity.

Example 4 includes the compute device of any of examples 1, 2, or 3, wherein one or more of the at least one programmable circuit is to, from candidate data path templates, select (1) a first candidate data path template for a first data path between the first application and the interface circuitry and (2) a second candidate data path template for a second data path between the second application and the interface circuitry.

Example 5 includes the compute device of example 4, wherein one or more of the at least one programmable circuit is to adjust the compute device based on the first candidate data path template and the second candidate data path template to configure the first data path and the second data path, respectively.

Example 6 includes the compute device of any of examples 4 or 5, wherein one or more of the at least one programmable circuit is to verify that the first candidate data path template and the second candidate data path template (1) do not interfere and (2) satisfy the first schedule and the second schedule, respectively.

Example 7 includes the compute device of any of examples 4, 5, or 6, wherein respective ones of the candidate data path templates describe a structure of a candidate data path and an estimated QoS metric provided by the candidate data path.

Example 8 includes the compute device of example 1, wherein the first VEE and the second VEE are to, based on respective quality of service (QoS) configurations for the first application and the second application, configure respective data paths between the first application and the interface circuitry and the second application and the interface circuitry, the respective QoS configurations coordinated with one another.

Example 9 includes the compute device of any of examples 1 or 8, wherein the first VEE and the second VEE are to cause transmission of respective TSN requirements for the first application and the second application to a management entity.

Example 10 includes the compute device of any of examples 1, 8, or 9, wherein the first VEE and the second VEE are to, from candidate data path templates, select respective candidate data path templates for respective data paths between the first application and the interface circuitry and the second application and the interface circuitry.

Example 11 includes the compute device of example 10, wherein the first VEE and the second VEE are to adjust the compute device based on the respective candidate data path templates to configure the respective data paths.

Example 12 includes the compute device of any of examples 10 or 11, wherein the interface circuitry is to, based on (1) the respective candidate data path templates not interfering and (2) the respective candidate data path templates satisfying the first schedule and the second schedule, permit configuration of the respective data paths.

Example 13 includes the compute device of example 12, wherein the interface circuitry is to, based on (3) the respective candidate data path templates interfering or (4) at least one of the respective candidate data path templates not satisfying the first schedule and the second schedule, notify the first VEE and the second VEE that the respective candidate data path templates were not accepted.

Example 14 includes a non-transitory computer-readable medium comprising instructions to cause at least one programmable circuit of a compute device to execute a first application for a time-sensitive network (TSN) in a first virtual execution environment (VEE), execute a second application for the TSN in a second VEE, cause first real-time traffic to be sent from the first application to interface circuitry at a first time, and cause second real-time traffic to be sent from the second application to the interface circuitry at a second time that does not overlap with the first time.

Example 15 includes the non-transitory computer-readable medium of example 14, wherein the instructions cause one or more of the at least one programmable circuit to, based on a quality of service configuration for the compute device, configure (1) a first data path between the first application and the interface circuitry and (2) a second data path between the second application and the interface circuitry.

Example 16 includes the non-transitory computer-readable medium of any of examples 14 or 15, wherein the instructions cause one or more of the at least one programmable circuit to, based on respective TSN requirements for the first application and the second application, generate combined TSN requirements for the compute device, and cause transmission of the combined TSN requirements to a network management entity.

Example 17 includes the non-transitory computer-readable medium of any of examples 14, 15, or 16, wherein the instructions cause one or more of the at least one programmable circuit to, from candidate data path templates, select (1) a first candidate data path template for a first data path between the first application and the interface circuitry and (2) a second candidate data path template for a second data path between the second application and the interface circuitry.

Example 18 includes the non-transitory computer-readable medium of example 17, wherein the instructions cause one or more of the at least one programmable circuit to adjust the compute device based on the first candidate data path template and the second candidate data path template to configure the first data path and the second data path, respectively.

Example 19 includes the non-transitory computer-readable medium of any of examples 17 or 18, wherein the first time is based on a first schedule, the second time is based on a second schedule, and the instructions cause one or more of the at least one programmable circuit to verify that the first candidate data path template and the second candidate data path template (1) do not interfere and (2) satisfy the first schedule and the second schedule, respectively.

Example 20 includes the non-transitory computer-readable medium of any of examples 17, 18, or 19, wherein respective ones of the candidate data path templates describe a structure of a candidate data path and an estimated QoS metric provided by the candidate data path.

Example 21 includes the non-transitory computer-readable medium of example 14, wherein the instructions cause one or more of the at least one programmable circuit to, with the first VEE and the second VEE, configure, based on respective quality of service (QoS) configurations for the first application and the second application, respective data paths between the first application and the interface circuitry and the second application and the interface circuitry, the respective QoS configurations coordinated with one another.

Example 22 includes the non-transitory computer-readable medium of any of examples 14 or 21, wherein the instructions cause one or more of the at least one programmable circuit to, with the first VEE and the second VEE, cause transmission of respective TSN requirements for the first application and the second application to a network management entity.

Example 23 includes the non-transitory computer-readable medium of any of examples 14, 21, or 22, wherein the instructions cause one or more of the at least one programmable circuit to, with the first VEE and the second VEE, select, from candidate data path templates, respective candidate data path templates for respective data paths between the first application and the interface circuitry and the second application and the interface circuitry.

Example 24 includes the non-transitory computer-readable medium of example 23, wherein the instructions cause one or more of the at least one programmable circuit to, with the first VEE and the second VEE, adjust the compute device based on the respective candidate data path templates to configure the respective data paths.

Example 25 includes a compute device comprising interface circuitry, first means for virtually executing a first application for a time-sensitive network (TSN), the first means for virtually executing to cause first real-time traffic to be sent from the first application to the interface circuitry based on a first schedule, and second means for virtually executing a second application for the TSN, the second means for virtually executing to cause second real-time traffic to be sent from the second application to the interface circuitry based on a second schedule such that transmission of the first real-time traffic does not occur at the same time as transmission of the second real-time traffic.

Example 26 includes the compute device of example 25, including means for configuring the compute device to, based on a quality of service configuration for the compute device, configure (1) a first data path between the first application and the interface circuitry and (2) a second data path between the second application and the interface circuitry.

Example 27 includes the compute device of any of examples 25 or 26, including means for configuring applications to, based on respective TSN requirements for the first application and the second application, generated combined TSN requirements for the compute device, and means for controlling the compute device to cause transmission of the combined TSN requirements to a network management entity.

Example 28 includes the compute device of any of examples 25, 26, or 27, including means for configuring the compute device to, from candidate data path templates, select (1) a first candidate data path template for a first data path between the first application and the interface circuitry and (2) a second candidate data path template for a second data path between the second application and the interface circuitry.

Example 29 includes the compute device of example 28, wherein the means for configuring the compute device is to, adjust the compute device based on the first candidate data path template and the second candidate data path template to configure the first data path and the second data path, respectively.

Example 30 includes the compute device of any of examples 28 or 29, wherein the means for configuring the compute device is to, verify that the first candidate data path template and the second candidate data path template (1) do not interfere and (2) satisfy the first schedule and the second schedule, respectively.

Example 31 includes the compute device of any of examples 28, 29, or 30, wherein respective ones of the candidate data path templates describe a structure of a candidate data path and an estimated QoS metric provided by the candidate data path.

Example 32 includes the compute device of example 25, wherein the first means for virtually executing and the second means for virtually executing are to, based on respective quality of service (QoS) configuration for the first application and the second application, configure respective data paths between the first application and the interface circuitry and the second application and the interface circuitry, the respective QoS configurations coordinated with one another.

Example 33 includes the compute device of any of examples 25 or 32, wherein the first means for virtually executing and the second means for virtually executing are to cause transmission of respective TSN requirements for the first application and the second application to a network management entity.

Example 34 includes the compute device of any of examples 25, 32, or 33, wherein the first means for virtually executing and the second means for virtually executing are to, from candidate data path templates, select respective candidate data path templates for respective data paths between the first application and the interface circuitry and the second application and the interface circuitry.

Example 35 includes the compute device of example 34, wherein the first means for virtually executing and the second means for virtually executing are to adjust the compute device based on the respective candidate data path templates to configure the respective data paths.

Example 36 includes the compute device of any of examples 34 or 35, wherein the interface circuitry includes means for verifying data paths to, based on (1) the respective candidate data path templates not interfering and (2) the respective candidate data path templates satisfying the first schedule and the second schedule, permit configuration of the respective data paths.

Example 37 includes the compute device of example 36, wherein the means for verifying is to, based on (3) the respective candidate data path templates interfering or (4) at least one of the respective candidate data path templates not satisfying the first schedule and the second schedule, notify the first means for virtually executing and the second means for virtually executing that the respective candidate data path templates were not accepted.

Example 38 includes a method comprising executing, with at least one programmable circuit, a first application for a time-sensitive network (TSN) in a first virtual execution environment (VEE) of a compute device, executing, with one or more of the at least one programmable circuit, a second application for the TSN in a second VEE of the compute device, sending, by executing an instruction with one or more of the at least one programmable circuit, first real-time traffic from the first application to interface circuitry based on a first schedule, and sending, by executing an instruction with one or more of the at least one programmable circuit, second real-time traffic from the second application to the interface circuitry based on a second schedule such that transmission of the first real-time traffic does not occur at the same time as transmission of the second real-time traffic.

Example 39 includes the method of example 38, including, based on a quality of service configuration for the compute device, configuring (1) a first data path between the first application and the interface circuitry and (2) a second data path between the second application and the interface circuitry.

Example 40 includes the method of any of examples 38 or 39, including, based on respective TSN requirements for the first application and the second application, generating combined TSN requirements for the compute device, and transmitting the combined TSN requirements to a network management entity.

Example 41 includes the method of any of examples 38, 39, or 40, including, from candidate data path templates, selecting (1) a first candidate data path template for a first data path between the first application and the interface circuitry and (2) a second candidate data path template for a second data path between the second application and the interface circuitry.

Example 42 includes the method of example 41, including adjusting the compute device based on the first candidate data path template and the second candidate data path template to configure the first data path and the second data path, respectively.

Example 43 includes the method of any of examples 41 or 42, including verifying that the first candidate data path template and the second candidate data path template (1) do not interfere and (2) satisfy the first schedule and the second schedule, respectively.

Example 44 includes the method of any of examples 41, 42, or 43, wherein respective ones of the candidate data path templates describe a structure of a candidate data path and an estimated QoS metric provided by the candidate data path.

Example 45 includes the method of example 38, including, based on respective quality of service (QoS) configurations for the first application and the second application, configuring, with the first VEE and the second VEE, respective data paths between the first application and the interface circuitry and the second application and the interface circuitry, the respective QoS configurations coordinated with one another.

Example 46 includes the method of any of examples 38 or 45, including causing, with the first VEE and the second VEE, transmission of respective TSN requirements for the first application and the second application to a network management entity.

Example 47 includes the method of any of examples 38, 45, or 46, including, from candidate data path templates, selecting, with the first VEE and the second VEE, respective candidate data path templates for respective data paths between the first application and the interface circuitry and the second application and the interface circuitry.

Example 48 includes the method of example 47, including adjusting, with the first VEE and the second VEE, the compute device based on the respective candidate data path templates to configure the respective data paths.

Example 49 includes the method of any of examples 47 or 48, including, based on (1) the respective candidate data path templates not interfering and (2) the respective candidate data path templates satisfying the first schedule and the second schedule, permitting, with the interface circuitry, configuration of the respective data paths.

Example 50 includes the method of example 49, including based on (3) the respective candidate data path templates interfering or (4) at least one of the respective candidate data path templates not satisfying the first schedule and the second schedule, notifying, with the interface circuitry, the first VEE and the second VEE that the respective candidate data path templates were not accepted.

Example 51 includes a non-transitory computer-readable medium comprising instructions to cause at least one programmable circuit of a compute device to manage multiple virtualized time-sensitive networking (TSN) end stations on a same host device.

Example 52 includes the non-transitory computer-readable medium of example 51, wherein the instructions cause one or more of the at least one programmable circuit to, based on a quality of service configuration for the host device, configure respective data paths between the multiple virtualized TSN end stations and interface circuitry of the host device.

Example 53 includes the non-transitory computer-readable medium of any of examples 51 or 52, wherein the instructions cause one or more of the at least one programmable circuit to based on respective TSN requirements for the multiple virtualized TSN end stations, generate combined TSN requirements for the host device, and cause transmission of the combined TSN requirements to a network management entity.

Example 54 includes the non-transitory computer-readable medium of any of examples 51, 52, or 53, wherein the instructions cause one or more of the at least one programmable circuit to, from candidate data path templates, select respective candidate data path templates for respective data paths between the multiple virtualized TSN end stations and interface circuitry of the host device.

Example 55 includes the non-transitory computer-readable medium of example 51, wherein the instructions cause one or more of the at least one programmable circuit to, with the multiple virtualized TSN end stations, configure respective data paths between the multiple virtualized TSN end stations and interface circuitry of the host device based on respective quality of service (QoS) configurations for the multiple virtualized TSN end stations, the respective QoS configurations coordinated with one another.

Example 56 includes the non-transitory computer-readable medium of any of examples 51 or 55, wherein the instructions cause one or more of the at least one programmable circuit to, with the multiple virtualized TSN end stations, cause transmission of respective TSN requirements for the multiple virtualized TSN end stations to a network management entity.

Example 57 includes the non-transitory computer-readable medium of any of examples 51, 55, or 56, wherein the instructions cause one or more of the at least one programmable circuit to, with the multiple virtualized TSN end stations, select, from candidate data path templates, respective candidate data path templates for respective data paths between the multiple virtualized TSN end stations and interface circuitry of the host device.

An apparatus comprising means to perform a method as described in any of examples 38-50.

Machine-readable storage including machine-readable instructions to, when executed, realize an apparatus as described in any of examples 1-13 or any of examples 25-37 or to, when executed, implement a method as described in any of examples 38-50.

A computer program comprising instructions which, when the program is executed by a computer, cause the computer to carry out the method as described in any of examples 38-50.

A machine-readable medium including code to, when executed, cause a machine to perform the method of any one of examples 38 to 50.

A computer program product comprising instruction which, when executed by a processor, cause the processor to perform the method of any one of examples 38-50.

A computer program which causes a processor to perform the method as described in examples 38 through 50.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A compute device comprising:
interface circuitry;
machine-readable instructions; and
at least one programmable circuit to be programmed by the machine-readable instructions to:
execute a first application for a time-sensitive network (TSN) in a first virtual execution environment (VEE);
execute a second application for the TSN in a second VEE;
cause first real-time traffic to be sent from the first application to the interface circuitry based on a first schedule; and
cause second real-time traffic to be sent from the second application to the interface circuitry based on a second schedule such that transmission of the first real-time traffic does not occur at the same time as transmission of the second real-time traffic.

2. The compute device of claim 1, wherein one or more of the at least one programmable circuit is to, based on a quality of service configuration for the compute device, configure (1) a first data path between the first application and the interface circuitry and (2) a second data path between the second application and the interface circuitry.

3. The compute device of claim 1, wherein one or more of the at least one programmable circuit is to:
based on respective TSN requirements for the first application and the second application, generate combined TSN requirements for the compute device; and
cause transmission of the combined TSN requirements to a network management entity.

4. The compute device of claim 1, wherein one or more of the at least one programmable circuit is to, from candidate data path templates, select (1) a first candidate data path template for a first data path between the first application and the interface circuitry and (2) a second candidate data path template for a second data path between the second application and the interface circuitry.

5. The compute device of claim 4, wherein one or more of the at least one programmable circuit is to adjust the compute device based on the first candidate data path template and the second candidate data path template to configure the first data path and the second data path, respectively.

6. The compute device of claim 4, wherein one or more of the at least one programmable circuit is to verify that the first candidate data path template and the second candidate data path template (1) do not interfere and (2) satisfy the first schedule and the second schedule, respectively.

7. The compute device of claim 4, wherein respective ones of the candidate data path templates describe a structure of a candidate data path and an estimated QoS metric provided by the candidate data path.

8. The compute device of claim 1, wherein the first VEE and the second VEE are to, based on respective quality of service (QoS) configurations for the first application and the second application, configure respective data paths between the first application and the interface circuitry and the second application and the interface circuitry, the respective QoS configurations coordinated with one another.

9. The compute device of claim 1, wherein the first VEE and the second VEE are to cause transmission of respective TSN requirements for the first application and the second application to a network management entity.

10. The compute device of claim 1, wherein the first VEE and the second VEE are to, from candidate data path templates, select respective candidate data path templates for respective data paths between the first application and the interface circuitry and the second application and the interface circuitry.

11. The compute device of claim 10, wherein the first VEE and the second VEE are to adjust the compute device based on the respective candidate data path templates to configure the respective data paths.

12. The compute device of claim 10, wherein the interface circuitry is to, based on (1) the respective candidate data path templates not interfering and (2) the respective candidate data path templates satisfying the first schedule and the second schedule, permit configuration of the respective data paths.

13. The compute device of claim 12, wherein the interface circuitry is to, based on (3) the respective candidate data path templates interfering or (4) at least one of the respective candidate data path templates not satisfying the first schedule and the second schedule, notify the first VEE and the second VEE that the respective candidate data path templates were not accepted.

14.-24. (canceled)

25. A compute device comprising:
interface circuitry;
first means for virtually executing a first application for a time-sensitive network (TSN), the first means for virtually executing to cause first real-time traffic to be sent from the first application to the interface circuitry based on a first schedule; and
second means for virtually executing a second application for the TSN, the second means for virtually executing to cause second real-time traffic to be sent from the second application to the interface circuitry based on a second schedule such that transmission of the first real-time traffic does not occur at the same time as transmission of the second real-time traffic.

26. The compute device of claim 25, including means for configuring the compute device to, based on a quality of service configuration for the compute device, configure (1) a first data path between the first application and the interface circuitry and (2) a second data path between the second application and the interface circuitry.

27.-50. (canceled)

51. A non-transitory computer-readable medium comprising instructions to cause at least one programmable circuit of a compute device to manage multiple virtualized time-sensitive networking (TSN) end stations on a same host device.

52. The non-transitory computer-readable medium of claim 51, wherein the instructions cause one or more of the at least one programmable circuit to, based on a quality of service configuration for the host device, configure respective data paths between the multiple virtualized TSN end stations and interface circuitry of the host device.

53. The non-transitory computer-readable medium of claim 51, wherein the instructions cause one or more of the at least one programmable circuit to:
based on respective TSN requirements for the multiple virtualized TSN end stations, generate combined TSN requirements for the host device; and
cause transmission of the combined TSN requirements to a network management entity.

54. (canceled)

55. The non-transitory computer-readable medium of claim 51, wherein the instructions cause one or more of the at least one programmable circuit to, with the multiple virtualized TSN end stations, configure respective data paths between the multiple virtualized TSN end stations and interface circuitry of the host device based on respective quality of service (QoS) configurations for the multiple virtualized TSN end stations, the respective QoS configurations coordinated with one another.

56. The non-transitory computer-readable medium of claim 51, wherein the instructions cause one or more of the at least one programmable circuit to, with the multiple virtualized TSN end stations, cause transmission of respective TSN requirements for the multiple virtualized TSN end stations to a network management entity.

57. (canceled)
